(19) United States
(12) Patent Application Publication
(10) Pub. No.: US 2015/0300379 A1
(43) Pub. Date: Oct. 22, 2015

(54) CYLINDER CONTROL DEVICE

(71) Applicant: KAYABA INDUSTRY CO., LTD., Tokyo (JP)

(72) Inventors: Takuya KUBOTA, Gifu (JP); Yuuzou MASUTA, Gifu (JP)

(73) Assignee: KAYABA INDUSTRY CO., LTD., Tokyo (JP)

(21) Appl. No.: 14/440,593

(22) PCT Filed: Oct. 29, 2013
(86) PCT No.: PCT/JP2013/079210

§ 371 Date: May 4, 2015

(30) Foreign Application Priority Data
Nov. 5, 2012 (JP) 2012-243282

(51) Int. Cl. F15B 11/04; F15B 15/18; F15B 11/08

(52) U.S. Cl. CPC F15B 11/04; F15B 11/08; F15B 15/18

(57) ABSTRACT

In a cylinder control device comprising a control valve that controls a flow of working fluid flowing between a cylinder and a pump, the control valve includes a spool provided in a main body portion, a sleeve that is provided in the main body portion opposite each of two end portions of the spool, and includes a communicating port that communicates with a valve chamber, a communicating passage that communicates with a cylinder chamber, and a throttle passage that communicates with the cylinder chamber, a valve body provided in the sleeve to control a communication state between the communicating port and the communicating passage and throttle passage in accordance with a sliding position thereof, and a biasing member that biases the valve body in a valve closing direction.

### TECHNICAL FIELD

This invention relates to a cylinder control device that controls expansion and contraction operations of a cylinder using a working fluid.

### BACKGROUND ART

JP2006-105226A discloses a hydraulic cylinder control device including a cylinder, a pump that pumps working oil as a working fluid, a tank that stores the working oil, a switch valve that controls a flow of the working oil between the pump and the tank, and an operation check valve that controls a flow of the working oil between the cylinder and the pump.

### SUMMARY OF INVENTION

In the cylinder control device shown in FIGS. 10 and 11 of JP2006-105226A, a slow return valve is disposed in an oil passage connecting the cylinder to the operation check valve. The slow return valve is configured to pass working oil flowing into the cylinder freely and to apply resistance to working oil discharged from the cylinder. The slow return valve is thus capable of preventing hunting that occurs when the operation check valve is moved to a neutral position by an external force (a weight of a load, for example) applied during expansion and contraction of the cylinder in an identical direction to an expansion/contraction direction.

As described above, the cylinder control device disclosed in JP2006-105226A includes the slow return valve in addition to the operation check valve and the switch valve, and therefore a number of constituent components of the device is large, making assembly of the device laborious.

An object of this invention is therefore to provide a cylinder control device with which reductions can be achieved in a number of components and a number of assembly processes.

According to one aspect of the present invention, a cylinder control device includes a cylinder driven by a fluid pressure of a working fluid in each of two cylinder chambers, a pump provided with two ports, the pump discharging the working fluid selectively from any of the two ports, and a control valve configured to control a flow of the working fluid, the working fluid flowing between the cylinder and the pump. The control valve includes a main body portion, a spool slidably provided in the main body portion, sleeves provided in the main body portion so as to be respectively opposed to end portions of the spool, valve chambers being respectively defined between the sleeves and the end portions of the spool, the valve chambers being respectively connected to the ports, the sleeves having communicating ports respectively communicating with the valve chambers and supply/discharge ports respectively communicating with the cylinder chambers, valve bodies respectively provided in the sleeves slidably, each of the valve bodies being configured to control a communication state between the communicating port and the supply/discharge port in accordance with a sliding position thereof, and biasing members configured to respectively bias the valve bodies in a direction for closing the corresponding communicating port. When the pump does not discharge the working fluid, the two valve bodies respectively close the communicating ports in response to biasing forces of the biasing members so that communication between the valve chambers and the cylinder chambers is respectively blocked. When the pump discharges the working fluid into one of the valve chambers from one of the ports, one of the valve bodies is moved against the biasing force of the corresponding biasing member by means of the fluid pressure in the one valve chamber so as to allow the working fluid to flow from the one valve chamber toward one of the cylinder chambers through one of the supply/discharge ports, and the other valve body is pushed by the spool and is moved against the biasing force of the corresponding biasing member so that a larger resistance than a resistance applied to the working fluid passing through the one supply/discharge port is applied to the working fluid passing through the other supply/discharge port to allow the working fluid to flow from the other cylinder chamber toward the other valve chamber through the other supply/discharge port, the spool being moved by the fluid pressure in the one valve chamber.

### BRIEF DESCRIPTION OF DRAWINGS

FIG. 1 is a pattern diagram showing a cylinder control device according to an embodiment of this invention.

FIG. 2 is a schematic view of a cylinder control device according to a first embodiment of this invention.

FIG. 3 is a schematic view showing the cylinder control device according to the first embodiment of this invention during a cylinder expansion operation.

FIG. 4 is a schematic view showing the cylinder control device according to the first embodiment of this invention during a cylinder contraction operation.

FIG. 5 is a plan view showing a sleeve of a cylinder control device according to a second embodiment of this invention.

FIG. 6 is a schematic view of the cylinder control device according to the second embodiment of this invention.

FIG. 7 is a schematic view showing the cylinder control device according to the second embodiment of this invention during a cylinder expansion operation.

FIG. 8 is a schematic view showing the cylinder control device according to the second embodiment of this invention when an external force of at least a reference value is exerted on the cylinder during the cylinder expansion operation.

FIG. 9 is a schematic view showing the cylinder control device according to the second embodiment of this invention during a cylinder contraction operation.

FIG. 10 is a plan view showing a sleeve of a cylinder control device according to a third embodiment of this invention.

FIG. 11 is a schematic view showing the cylinder control device according to the third embodiment of this invention.

FIG. 12 is a schematic view showing the cylinder control device according to the third embodiment of this invention during a cylinder expansion operation.

FIG. 13 is a schematic view showing a cylinder control device according to a fourth embodiment of this invention.

FIG. 14 is a schematic view showing the cylinder control device according to the fourth embodiment of this invention during a cylinder expansion operation.

FIG. 15 is a schematic view showing the cylinder control device according to the fourth embodiment of this invention in a state where a maximum movement position of a valve body is not restricted by a stopper during the cylinder expansion operation.

FIG. 16 is a schematic view showing the cylinder control device according to the fourth embodiment of this invention in a state where the maximum movement position of the valve body is maximally restricted by the stopper during the cylinder expansion operation.

FIG. 17 is a schematic view showing the cylinder control device according to the fourth embodiment of this invention during a cylinder contraction operation.

### DESCRIPTION OF EMBODIMENTS

Embodiments of this invention will be described below with reference to the figures.

### First Embodiment

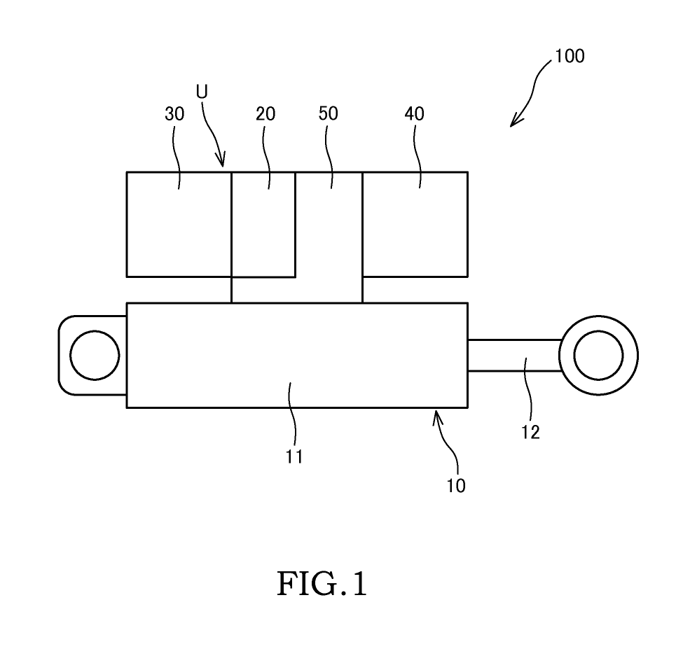

Referring to FIGS. 1 to 4, a cylinder control device 100 according to a first embodiment of this invention will be described.

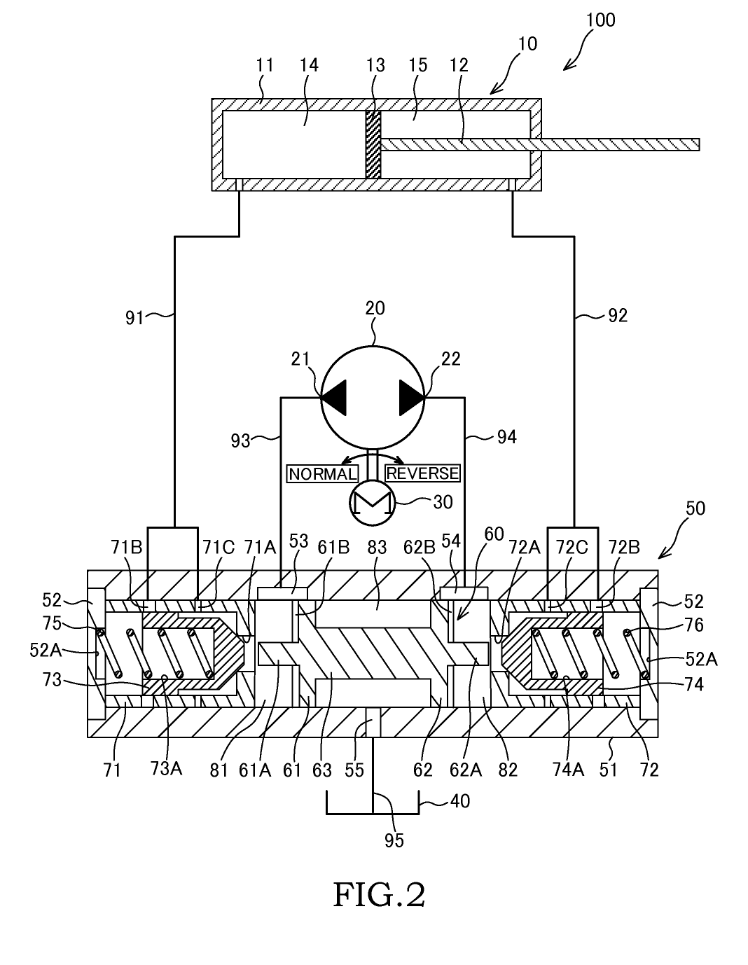

Referring to FIGS. 1 and 2, a configuration of the cylinder control device 100 will be described.

The cylinder control device 100 shown in FIGS. 1 and 2 is installed in an agricultural instrument, a working instrument, or the like in order to control expansion and contraction operations of a cylinder 10 using working oil.

The cylinder control device 100 includes the cylinder 10, which is configured to be capable of expanding and contracting, a pump 20 that pumps the working oil as a working fluid, a drive motor 30 that drives the pump 20, a tank 40 that stores the working oil, and a control valve 50 that controls respective flows of the working oil between the cylinder 10 and the pump 20 and between the pump 20 and the tank 40.

The pump 20, the drive motor 30, the tank 40, the control valve 50, and so on together constitute a single unit member U (see FIG. 1), and the unit member U is disposed adjacent to the cylinder 10. As a result, the cylinder control device 100 can be configured compactly.

As shown in FIG. 2, the cylinder 10 includes a cylindrical tubular portion 11, a piston rod 12 that is inserted into the tubular portion 11 from one end side of the tubular portion 11, and a piston 13 provided on an end portion of the piston rod 12 in order to slide along an inner peripheral surface of the tubular portion 11.

An interior of the tubular portion 11 is divided by the piston 13 into a first cylinder chamber 14 and a second cylinder chamber 15. Working oil is charged into the first cylinder chamber 14 and the second cylinder chamber 15.

The cylinder 10 is a double acting cylinder configured such that when the working oil is supplied to the first cylinder chamber 14 and discharged from the second cylinder chamber 15, the piston rod 12 moves in an expansion direction, and when the working oil is supplied to the second cylinder chamber 15 and discharged from the first cylinder chamber 14, the piston rod 12 moves in a contraction direction.

It should be noted that a base end portion of the tubular portion 11 of the cylinder 10 is fixed to a body of the agricultural instrument or the like in a predetermined position, and a tip end portion of the piston rod 12 positioned outside the tubular portion 11 is fixed to a driving subject (a load).

The pump 20 is a gear pump provided with a first port 21 and a second port 22. The pump 20 is connected to a rotary shaft of the drive motor 30, and driven on the basis of a rotary driving force of the drive motor 30. When a driveshaft of the drive motor 30 rotates normally, the pump 20 discharges working oil suctioned from the second port 22 through the first port 21, and when the drive shaft of the drive motor 30 rotates in reverse, the pump 20 discharges working oil suctioned from the first port 21 through the second port 22.

Hence, a discharge direction of the working oil discharged from the pump 20 is switched selectively in accordance with a rotation direction of the drive motor 30.

The control valve 50 is provided between the cylinder 10 and the pump 20. The first cylinder chamber 14 of the cylinder 10 is connected to the control valve 50 via a first cylinder passage 91, and the second cylinder chamber 15 of the cylinder 10 is connected to the control valve 50 via a second cylinder passage 92. The first port 21 of the pump 20 is connected to the control valve 50 via a first pump passage 93, and the second port 22 of the pump 20 is connected to the control valve 50 via a second pump passage 94. Further, the control valve 50 is connected to the tank 40 via a tank passage 95.

The control valve 50 includes a hollow main body portion 51, a spool 60 slidably provided in the main body portion 51, a first sleeve 71 and a second sleeve 72 provided in the main body portion 51 so as to be respectively opposed to end portions of the spool 60, a first valve body 73 and a second valve body 74 slidably provided respectively in the first sleeve 71 and the second sleeve 72, and a first spring 75 and a second spring 76 serving as biasing members configured to respectively bias the first valve body 73 and the second valve body 74.

A lid member 52 is provided on both end of the main body portion 51 so as to be freely attached and detached, and as a result, an interior of the main body portion 51 is formed as a sealed space. The various members constituting the control valve 50 are housed in this sealed space.

The spool 60 includes a first piston portion 61 and a second piston portion 62 that are disposed apart from each other in a sliding direction of the spool 60 so as to be capable of sliding relative to an inner peripheral surface of the main body portion 51, a connecting shaft 63 that connects the first piston portion 61 and the second piston portion 62 to each other, and a first projecting shaft 61A and a second projecting shaft 62A that project outwardly from respective outside end surfaces of the first piston portion 61 and the second piston portion 62. The first projecting shaft 61A is a member that pushes and moves the first valve body 73 in response to movement of the spool 60, and the second projecting shaft 62A is a member that pushes and moves the second valve body 74 in response to movement of the spool 60.

The first sleeve 71 and the second sleeve 72 are provided in the main body portion 51 so as to be opposed to an end portion of the spool 60 on the first piston portion 61 side and an end portion of the spool 60 on the second piston portion 62 side, respectively. A first valve chamber 81 is formed between the first sleeve 71 and the end portion of the spool 60, and a second valve chamber 82 is formed between the second sleeve 72 and the end portion of the spool 60. The spool 60 slides along the inner peripheral surface of the main body portion 51 in a left-right direction of the figure in accordance with an oil pressure of the working oil in the first valve chamber 81 and the second valve chamber 82.

A first valve connecting portion 53 and a second valve connecting portion 54 are formed in the main body portion 51 so as to communicate respectively with the first valve chamber 81 and the second valve chamber 82 at all times, regardless of a sliding position of the spool 60. The first valve connecting portion 53 is connected to the first port 21 of the pump 20 via the first pump passage 93, and the second valve connecting portion 54 is connected to the second port 22 of the pump 20 via the second pump passage 94.

Furthermore, a central oil chamber 83 is defined in the main body portion 51 by the inner peripheral surface of the main body portion 51, the first piston portion 61 and second piston portion 62 of the spool 60, and the connecting shaft 63 of the spool 60. The central oil chamber 83 is connected to the tank 40 via a tank connecting portion 55 formed in the main body portion 51, and the tank passage 95.

The tank connecting portion 55 is configured to connect the central oil chamber 83 to the tank 40 at all times, regardless of the sliding position of the spool 60. The first valve connecting portion 53, on the other hand, is configured to connect the first valve chamber 81 to the central oil chamber 83 in accordance with the sliding position of the spool 60. Further, the second valve connecting portion 54 is configured to connect the second valve chamber 82 to the central oil chamber 83 in accordance with the sliding position of the spool 60.

The first sleeve 71 provided opposite the end portion of the spool 60 is a cylindrical member. One end of the first sleeve 71 is formed as an open end, and another end is formed as a closed end. The first sleeve 71 is fixed within the main body portion 51 such that the open end contacts the lid member 52.

A communicating port 71A that communicates with the first valve chamber 81 is formed in the closed end of the first sleeve 71. The communicating port 71A is provided in a position corresponding to the first projecting shaft 61A of the spool 60, and formed so that the first projecting shaft 61A can be inserted therein. An inner diameter of the communicating port 71A is set to be larger than an outer diameter of the first projecting shaft 61A.

Further, a communicating passage 71B and a throttle passage 71C are formed in a side wall of the first sleeve 71 as supply/discharge ports communicating with the first cylinder passage 91. A connecting end of the first cylinder passage 91 on the control valve 50 side bifurcates into two connecting ends, one of which is connected to the communicating passage 71B and the other of which is connected to the throttle passage 71C. The communicating passage 71B and the throttle passage 71C thus communicate with the first cylinder chamber 14 through the first cylinder passage 91.

The communicating passage 71B and the throttle passage 71C are formed in the side wall of the first sleeve 71 on the open end side and the closed end side, respectively. The communicating passage 71B and the throttle passage 71C are provided apart from each other in a sliding direction of the first valve body 73, to be described below. In other words, the communicating passage 71B is formed in a position that is apart from a spool 60 side end surface (the closed end) of the first sleeve 71 compared with the throttle passage 71C. The communicating passage 71B is configured as an oil passage that passes the working oil freely, while the throttle passage 71C is configured as an oil passage that has a smaller flow passage area than that of the communicating passage 71B so as to apply resistance to the working oil passing through. A diameter of the throttle passage 71C is determined as desired in accordance with an envisaged external force acting on the cylinder.

The first valve body 73 is slidably provided relative to the inner peripheral surface of the first sleeve 71. The first valve body 73 is a bottomed cylindrical member, and is disposed such that a tip end portion thereof constituting a closed end faces the communicating port 71A side of the first sleeve 71. The first valve body 73 is configured such that the tip end portion of the first valve body 73 opens and closes the communicating port 71A of the first sleeve 71 and a side portion (a sliding wall) of the first valve body 73 opens and closes the communicating passage 71B of the first sleeve 71 in accordance with a sliding position of the first valve body 73.

The first spring 75 is provided in a compressed state between the first valve body 73 and the lid member 52. One end of the first spring 75 is inserted into the first valve body 73 from an open end side of a housing hole 73A provided in the first valve body 73 so as to contact a hole bottom of the housing hole 73A. Another end of the first spring 75 is housed in a spring housing hole 52A provided in an inside surface of the lid member 52 so as to contact a hole bottom of the spring housing hole 52A. The first spring 75 biases the first valve body 73 in a direction for closing the communicating port 71A of the first sleeve 71.

The first valve body 73 described above is pushed by the oil pressure in the first valve chamber 81 or by the first projecting shaft 61A of the spool 60 so as to move along the inner peripheral surface of the first sleeve 71. The first valve body 73 controls communication states between the communicating port 71A of the first sleeve 71 and the communicating passage 71B and between the communicating port 71A and throttle passage 71C in accordance with the valve body sliding position.

The second sleeve 72 provided opposite the end portion of the spool 60 is a cylindrical member, similarly to the first sleeve 71. One end of the second sleeve 72 is formed as an open end, and another end is formed as a closed end. The second sleeve 72 is fixed within the main body portion 51 such that the open end contacts the lid member 52.

A communicating port 72A that communicates with the second valve chamber 82 is formed in the closed end of the second sleeve 72. The communicating port 72A is provided in a position corresponding to the second projecting shaft 62A of the spool 60, and formed so that the second projecting shaft 62A can be inserted therein. An inner diameter of the communicating port 72A is set to be larger than an outer diameter of the second projecting shaft 62A.

Further, a communicating passage 72B and a throttle passage 72C are formed in a side wall of the second sleeve 72 so as to communicate with the second cylinder passage 92. A connecting end of the second cylinder passage 92 on the control valve 50 side bifurcates into two connecting ends, one of which is connected to the communicating passage 72B and the other of which is connected to the throttle passage 72C. The communicating passage 72B and the throttle passage 72C thus communicate with the second cylinder chamber 15 through the second cylinder passage 92.

The communicating passage 72B and the throttle passage 72C are formed in the side wall of the second sleeve 72 on the open end side and the closed end, respectively. The communicating passage 72B and the throttle passage 72C are provided apart from each other in a sliding direction of the second valve body 74, to be described below. In other words, the communicating passage 72B is formed in a position that is apart from a spool 60 side end surface (the closed end) of the second sleeve 72 compared with the throttle passage 72C. The communicating passage 72B is configured as an oil passage that passes the working oil freely, while the throttle passage 72C is configured as an oil passage that has a smaller flow passage area than that of the communicating passage 72B so as to apply resistance to the working oil passing through. A diameter of the throttle passage 72C is determined as desired in accordance with the envisaged external force acting on the cylinder.

The second valve body 74 is slidably provided relative to the inner peripheral surface of the second sleeve 72. The second valve body 74 is a bottomed cylindrical member, and is disposed such that a tip end portion thereof constituting a closed end faces the communicating port 72A side of the second sleeve 72. The second valve body 74 is configured such that the tip end portion of the second valve body 74 opens and closes the communicating port 72A of the second sleeve 72 and a side portion (a sliding wall) of the second valve body 74 opens and closes the communicating passage 72B of the second sleeve 72 in accordance with a sliding position of the second valve body 74.

The second spring 76 is provided in a compressed state between the second valve body 74 and the lid member 52. One end of the second spring 76 is inserted into the second valve body 74 from an open end side of a housing hole 74A provided in the second valve body 74 so as to contact a hole bottom of the housing hole 74A. Another end of the second spring 76 is housed in a spring housing hole 52A provided in an inside surface of the lid member 52 so as to contact a hole bottom of the spring housing hole 52A. The second spring 76 biases the second valve body 74 in a direction for closing the communicating port 72A of the second sleeve 72.

The second valve body 74 described above is pushed by the oil pressure in the second valve chamber 82 or by the second projecting shaft 62A of the spool 60 so as to move along the inner peripheral surface of the second sleeve 72. The second valve body 74 controls a communication state between the communicating port 72A of the second sleeve 72 and the communicating passage 72B and throttle passage 72C in accordance with the valve body sliding position.

Next, referring to FIGS. 2 to 4, operation control performed on the cylinder 10 by the cylinder control device 100 will be described.

As shown in FIG. 2, when the drive motor 30 is stopped so that the pump 20 is out of operation, the spool 60 is positioned in a neutral position (an initial position) in which communications between the central oil chamber 83 and the first valve chamber 81 and between the central oil chamber 83 and second valve chamber 82 are blocked by the first piston portion 61 and second piston portion 62 of the sleeve 60.

At this time, the tip end portion of the first valve body 73 closes the communicating port 71A of the first sleeve 71 due to a biasing force of the first spring 75, and the tip end portion of the second valve body 74 closes the communicating port 72A of the second sleeve 72 due to a biasing force of the second spring 76. Hence, communication between the first cylinder chamber 14 and the first valve chamber 81 and communication between the second cylinder chamber 15 and the second valve chamber 82 are blocked, and as a result, the working oil in the first cylinder chamber 14 and the second cylinder chamber 15 remains in a static state. Accordingly, the cylinder 10 remains in a load holding state in which the control subject (the load) is held in a predetermined position.

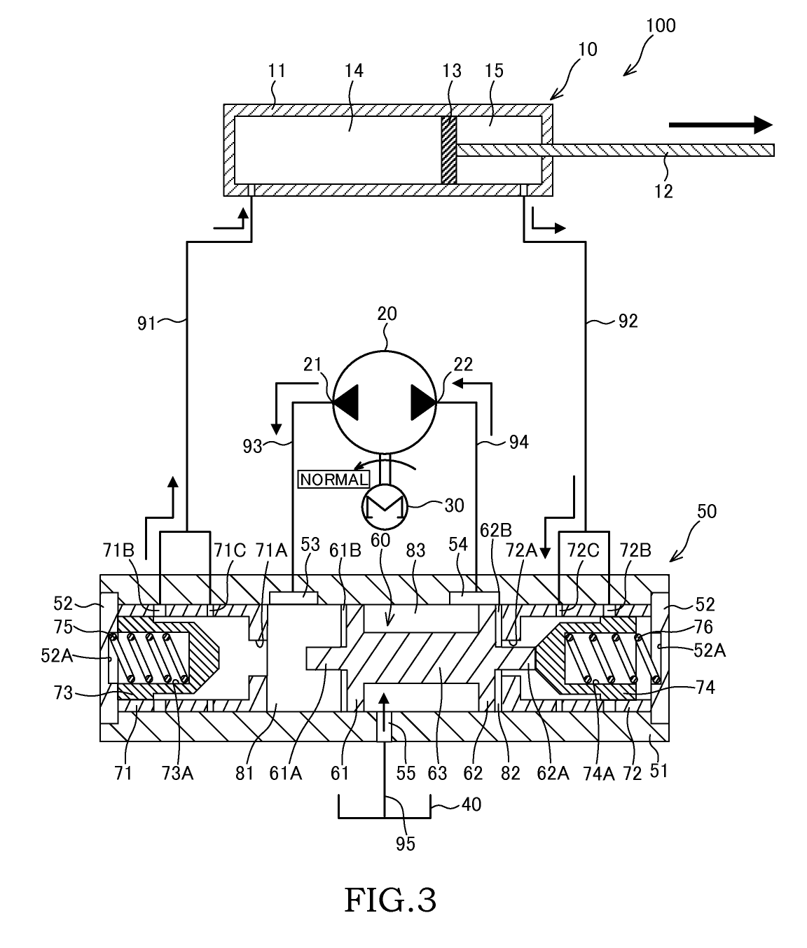

To cause the cylinder 10 to expand, as shown in FIG. 3, the drive motor 30 is rotated normally.

When the drive motor 30 rotates normally, the pump 20 discharges the working oil suctioned from the second port 22 through the first port 21. As a result, the oil pressure in the first valve chamber 81 increases so that the first valve body 73 is moved by this oil pressure to the lid member 52 side against the biasing force of the first spring 75. The first valve body 73 is pushed down by the oil pressure in the first valve chamber 81 to a maximum movement position (a second position) in which the open end thereof contacts the lid member 52. In a state where the first valve body 73 has moved to the maximum movement position, which is further outward than a midway position (a first position) to be described below, the communicating port 71A of the first sleeve 71 communicates with the communicating passage 71B.

When the first valve body 73 is opened by the oil pressure in the first valve chamber 81, the throttle passage 71C also communicates with the communicating port 71A, but since the throttle passage 71C functions as a throttle, the working oil in the first valve chamber 81 flows into the first cylinder passage 91 mainly through the communicating port 71A and the communicating passage 71B, whereupon the working oil flows through the first cylinder passage 91 into the first cylinder chamber 14. Hence, when the first valve body 73 is opened by the oil pressure in the first valve chamber 81, the working oil is allowed to flow from the first valve chamber 81 toward the first cylinder chamber 14.

When the drive motor 30 rotates normally, the spool 60 is moved in a rightward direction of the figure from the neutral position (see FIG. 2) toward the second sleeve 72 by the oil pressure in the first valve chamber 81. When the spool 60 moves toward the second sleeve 72 in the rightward direction of the figure, the second projecting shaft 62A of the spool 60 contacts the tip end portion of the second valve body 74 through the communicating port 72A in the second sleeve 72. The spool 60 moves until the outside end surface of the second piston portion 62 contacts the closed end of the second sleeve 72, and therefore the second valve body 74 is pushed down by the second projecting shaft 62A in the rightward direction of the figure against the biasing force of the second spring 76 from an initial position closing the communicating port 72A to the midway position (the first position), in which the communicating passage 72B is closed and the communicating port 72A communicates only with the throttle passage 72C. In a state where the second valve body 74 has moved to the midway position in this manner, the communicating port 72A, into which the second projecting shaft 62A is inserted, communicates with the throttle passage 72C, while the communicating passage 72B is maintained in a closed state by a side wall of the second valve body 74.

It should be noted that a length of the second projecting shaft 62A of the spool 60 is set such that when the second piston portion 62 of the spool 60 contacts the end surface of the second sleeve 72, the second valve body 74 is pushed down to the midway position by the second projecting shaft 62A of the spool 60.

When the spool 60 is pushed so that the second valve body 74 is opened, the working oil in the second cylinder chamber 15 is discharged to the second valve chamber 82 side through the second cylinder passage 92, the throttle passage 72, and the communicating port 72A. Hence, when the second valve body 74 is opened by the spool 60, the second valve body 74 moves so as to open only the throttle passage 72C, which applies greater resistance than that of the communicating passage 71B opened by the first valve body 73, and as a result, the working oil is permitted to flow from the second cylinder chamber 15 toward the second valve chamber 82.

It should be noted that a cutout groove 62B is formed as a recess in the outside end surface of the second piston portion 62 of the spool 60, and when the second piston portion 62 contacts the second sleeve 72, the cutout groove 62B functions as the second valve chamber 82, thereby connecting the communicating port 72A to the second valve connecting portion 54. As a result, the working oil that flows out of the communicating port 72A in the second sleeve 72 is led to the pump 20 through the cutout groove 62B, the second valve connecting portion 54, and the second pump passage 94.

When the spool 60 moves to the second sleeve 72 side from the neutral position, the second valve connecting portion 54 communicates with the central oil chamber 83, while the first valve connecting portion 53 remains blocked from the central oil chamber 83 by the first piston portion 61. Accordingly, the working oil is permitted to flow from the tank 40 toward the second valve connecting portion 54. As a result, working oil from the tank 40 is led to the pump 20 in addition to the working oil from the second cylinder chamber 15. An amount of working oil supplied to the pump 20 from the tank 40 corresponds to a rod volume by which the piston rod 12 retreats outwardly from the second cylinder chamber 15.

When the working oil is supplied to the first cylinder chamber 14 and discharged from the second cylinder chamber 15 in the manner described above, the piston rod 12 moves in the expansion direction, and as a result, the cylinder 10 expands.

When the cylinder 10 expands, the working oil in the first valve chamber 81 is supplied to the first cylinder chamber 14 through the communicating passage 71B and the throttle passage 71C (mainly the communicating passage 71B) of the first sleeve 71. The working oil discharged from the second cylinder chamber 15, meanwhile, is led to the second valve chamber 82 side through only the throttle passage 72C of the second sleeve 72. When the cylinder 10 expands, therefore, the supplied working oil passes mainly through the communicating passage 71B, whereas the discharged working oil passes through the throttle passage 71C that has a smaller flow passage area than that of the communicating passage 71B and therefore applies greater resistance to the working oil than the resistance applied by the communicating passage 71B. Hence, resistance is applied to the discharged working oil even when an external force acts on the piston rod 12 in the expansion direction, and therefore a reduction in pressure in the discharge side second cylinder chamber 15 is suppressed so that the cylinder 10 does not expand rapidly. Accordingly, the oil pressure in the first cylinder chamber 14 and the first valve chamber 81 does not decrease rapidly during expansion of the cylinder 10, and therefore the spool 60 can be prevented from returning to the neutral position. The spool 60 can therefore be stability biased by the oil pressure in the first valve chamber 81 so as to move in the rightward direction of the figure toward the second sleeve 72 side, whereby the second valve body 74 can be held at the midway position. Hence, the communication state between the communicating port 72A and the throttle passage 72C can be maintained, and as a result, hunting can be prevented from occurring during expansion of the cylinder 10.

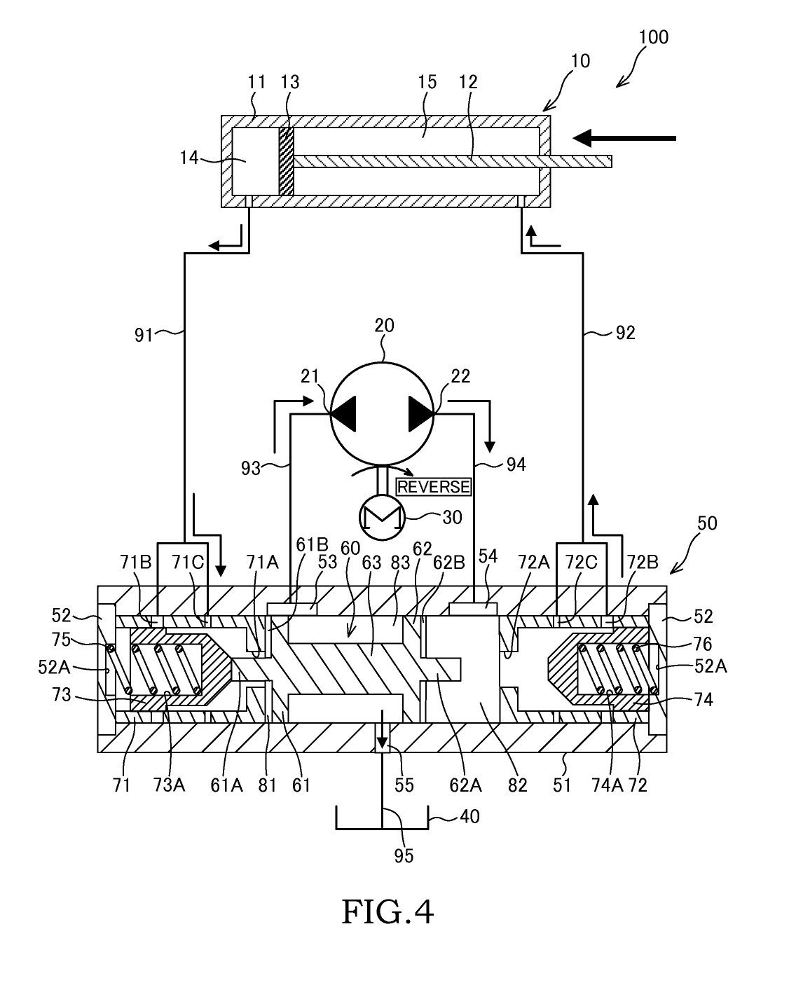

As shown in FIG. 4, to cause the cylinder 10 to contract, the drive motor 30 is rotated in reverse.

When the drive motor 30 rotates in reverse, the pump 20 discharges the working oil suctioned from the first port 21 through the second port 22. As a result, the oil pressure in the second valve chamber 82 increases so that the second valve body 74 is moved by this oil pressure to the lid member 52 side against the biasing force of the second spring 76. The second valve body 74 is pushed down by the oil pressure in the second valve chamber 82 to the maximum movement position (the second position) in which the open end thereof contacts the lid member 52. In a state where the second valve body 74 has moved to the maximum movement position, which is further outward than the midway position (the first position), the communicating port 72A of the second sleeve 72 communicates with the communicating passage 72B.

When the second valve body 74 is opened by the oil pressure in the second valve chamber 82, the throttle passage 72C also communicates with the communicating port 72A, but since the throttle passage 72C functions as a throttle, the working oil in the second valve chamber 82 flows into the second cylinder passage 92 mainly through the communicating port 72A and the communicating passage 72B, whereupon the working oil flows through the second cylinder passage 92 into the second cylinder chamber 15. Hence, when the second valve body 74 is opened by the oil pressure in the second valve chamber 82, the working oil is permitted to flow from the second valve chamber 82 toward the second cylinder chamber 15.

When the drive motor 30 rotates in reverse, the spool 60 is moved in a leftward direction of the figure from the neutral position (see FIG. 2) toward the first sleeve 71 by the oil pressure in the second valve chamber 82. When the spool 60 moves toward the first sleeve 71 in the leftward direction of the figure, the first projecting shaft 61A of the spool 60 contacts the tip end portion of the first valve body 73 through the communicating port 71A in the first sleeve 71. The spool 60 moves until the outside end surface of the first piston portion 61 contacts the closed end of the first sleeve 71, and therefore the first valve body 73 is pushed down by the first projecting shaft 61A in the leftward direction of the figure against the biasing force of the first spring 75 from an initial position closing the communicating port 71A to the midway position (the first position), in which the communicating passage 71B is closed and the communicating port 71A communicates only with the throttle passage 71C. In a state where the first valve body 73 has moved to the midway position in this manner, the communicating port 71A, into which the first projecting shaft 61A is inserted, communicates with the throttle passage 71C, while the communicating passage 71B is maintained in a closed state by a side wall of the first valve body 73.

It should be noted that a length of the first projecting shaft 61A of the spool 60 is set such that when the first piston portion 61 of the spool 60 contacts the end surface of the first sleeve 71, the first valve body 73 is pushed down to the midway position by the first projecting shaft 61A of the spool 60.

When the spool 60 is pushed so that the first valve body 73 is opened, the working oil in the first cylinder chamber 14 is discharged to the first valve chamber 81 side through the first cylinder passage 91, the throttle passage 71C, and the communicating port 71A. Hence, when the first valve body 73 is opened by the spool 60, the first valve body 73 moves so as to open only the throttle passage 71C, which applies greater resistance than that of the communicating passage 72B opened by the second valve body 74, and as a result, the working oil is permitted to flow from the first cylinder chamber 14 toward the first valve chamber 81.

A cutout groove 61B is formed as a recess in the outside end surface of the first piston portion 61 of the spool 60, and when the first piston portion 61 contacts the first sleeve 71, the cutout groove 61B functions as the first valve chamber 81, thereby connecting the communicating port 71A to the first valve connecting portion 53. As a result, the working oil that flows out of the communicating port 71A in the first sleeve 71 is led to the pump 20 through the cutout groove 61B, the first valve connecting portion 53, and the first pump passage 93.

When the spool 60 moves to the first sleeve 71 side from the neutral position, the first valve connecting portion 53 communicates with the central oil chamber 83, while the second valve connecting portion 54 and the central oil chamber 83 are maintained in a blocked state by the second piston portion 62. Accordingly, the working oil is permitted to flow from the first valve connecting portion 53 toward the tank 40, and therefore a part of the working oil discharged from the first cylinder chamber 14 is led to the tank 40. An amount of working oil corresponding to a rod volume by which the piston rod 12 enters into the second cylinder chamber 15 flows into the tank 40.

When the working oil is supplied to the second cylinder chamber 15 and discharged from the first cylinder chamber 14 in the manner described above, the piston rod 12 moves in a contraction direction, and as a result, the cylinder 10 contracts.

When the cylinder 10 contracts, the working oil in the second valve chamber 82 is supplied to the second cylinder chamber 15 through the communicating passage 72B and the throttle passage 72C (mainly the communicating passage 72B) of the second sleeve 72. The working oil discharged from the first cylinder chamber 14, meanwhile, is led to the first valve chamber 81 side through only the throttle passage 71C of the first sleeve 71. When the cylinder 10 contracts, therefore, the supplied working oil passes mainly through the communicating passage 72B, whereas the discharged working oil passes through the throttle passage 72C that has a smaller flow passage area than that of the communicating passage 72B and therefore applies greater resistance to the working oil than the resistance applied by the communicating passage 72B. Hence, resistance is applied to the discharged working oil even when an external force acts on the piston rod 12 in the contraction direction, and therefore a reduction in pressure in the discharge side first cylinder chamber 14 is suppressed so that the cylinder 10 does not contract rapidly. Accordingly, the oil pressure in the second cylinder chamber 15 and the second valve chamber 82 does not decrease rapidly during contraction of the cylinder 10, and therefore the spool 60 can be prevented from returning to the neutral position. The spool 60 can therefore be stability biased by the oil pressure in the second valve chamber 82 so as to move in the leftward direction of the figure toward the first sleeve 71, whereby the first valve body 73 can be held at the midway position. Hence, the communication state between the communicating port 71A and the throttle passage 71C can be maintained, and as a result, hunting can be prevented from occurring during contraction of the cylinder 10.

In the cylinder control device 100, therefore, the working oil discharged from one of the first and second cylinder chambers 14, 15 passes through the throttle passage 71C or 72C so that resistance is applied thereto, and as a result, a reduction in pressure in the discharge side cylinder chamber is suppressed. Hence, rapid expansion and contraction of the piston rod 12 due to an external force acting in an identical direction to an expansion/contraction direction is prevented by the pressure in the discharge side cylinder chamber. Accordingly, a situation in which the pressure in the valve chamber on the side to which the working oil is supplied decreases due to rapid expansion and contraction of the piston rod 12, causing the spool 60 to move to the neutral position, does not occur. As a result, hunting occurring when the first and second valve bodies 73, 74 move so as to block communication between the communicating ports 71A, 72A and the communicating passages 71B, 72B and between the communicating ports 71A, 72A and throttle passages 71C, 72C can be prevented.

When the external force acting on the cylinder is large, the diameters of the throttle passages are set to be small in order to prevent hunting by applying greater resistance to the working oil. When the external force acting on the cylinder is small, the diameters of the throttle passages 71C, 72C are set to be larger than when a large external force acts on the cylinder. Hence, the diameters of the throttle passages 71C, 72C are set as desired in accordance with the envisaged external force acting on the piston rod 12.

Further, in this embodiment, the control valve 50 opens the communicating passages 71B, 72B so that the communicating passages 71B, 72B communicate with the communicating ports 71A, 72A when the working oil is supplied to the cylinder 10, and blocks communication between the communicating passages 71B, 72B and the communicating ports 71A, 72A when the working oil is discharged. Hence, the resistance that is applied to the working oil supplied to the cylinder 10 and the working oil discharged from the cylinder 10 can be controlled by opening and closing the communicating passages 71B, 72B, and therefore the control is less complicated than that performed in a conventional cylinder control device.

According to the first embodiment, described above, following effects are obtained.

The control valve 50 of the cylinder control device 100 according to the first embodiment, described above, uses the first valve body 73, which controls the communication state between the communicating port 71A and the communicating passage 71B and between the communicating port 71A and throttle passage 71C of the first sleeve 71 using the oil pressure in the first valve chamber 81 or a pushing force from the first projecting shaft 61A of the spool 60, and the second valve body 74, which controls the communication state between the communicating port 72A and the communicating passage 72B and between the communicating port 72A and throttle passage 72C of the second sleeve 72 using the oil pressure in the second valve chamber 82 or a pushing force from the second projecting shaft 62A of the spool 60, to control the flow of working oil between the cylinder 10 and the pump 20 and prevent hunting during expansion and contraction of the cylinder 10.

The control valve 50 is configured to function as both the operation check valve that controls the flow of working oil between the cylinder and the pump and the slow return valve that prevents hunting during expansion and contraction of the cylinder in the conventional cylinder control device, and therefore reductions can be achieved in a number of constituent components of the cylinder control device 100 and a number of processes required to assemble the cylinder control device 100.

Further, the control valve 50 is configured to switch the flow of working oil between the pump 20 and the tank 40 in accordance with the sliding position of the spool 60, and therefore also functions as the switch valve of the conventional cylinder control device. As a result, further reductions can be achieved in the number of constituent components of the cylinder control device 100 and the number of processes required to assemble the cylinder control device 100.

### Second Embodiment

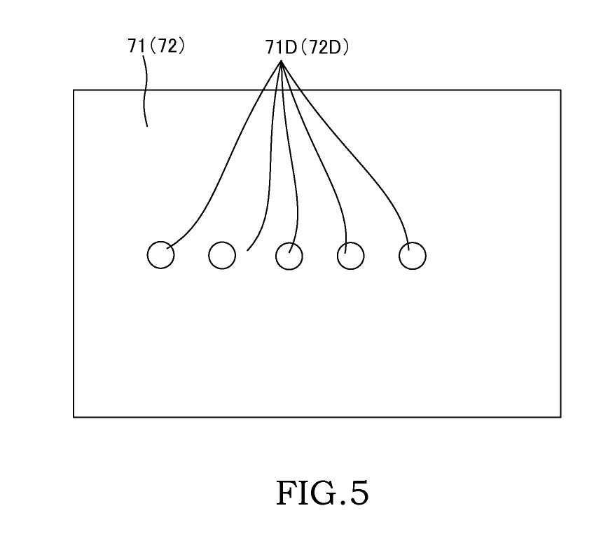

Next, referring to FIGS. 5 to 8, a cylinder control device 200 according to a second embodiment of this invention will be described. The following description focuses on differences with the first embodiment. Identical configurations to the cylinder control device 100 according to the first embodiment have been allocated identical reference symbols, and description thereof has been omitted.

In the cylinder control device 100 according to the first embodiment, described above, the communicating passages 71B, 72B and the throttle passages 71C, 72C formed respectively in the first and second sleeves 71, 72 serve as the supply/discharge ports that connect the first and second valve chambers 81, 82 to the first and second cylinder passages 91, 92. The diameters of the throttle passages 71C, 72C are determined in advance in accordance with the envisaged external force acting on the cylinder.

In other words, in the first embodiment, when a greater external force than the predicted external force acts on the cylinder, the resistance applied to the working oil by the preset throttle passages 71C, 72C is insufficient. In this case, the spool 60 may return to the neutral position, and as a result, hunting may occur. In the first embodiment, therefore, it is necessary to set the diameters of the throttle passages 71C, 72C individually in accordance with the envisaged external force. Accordingly, types of sleeves having throttle passages 71C, 72C with different diameters must be prepared in accordance with the magnitude of the envisaged external force.

The cylinder control device 200 differs from the cylinder control device 100 according to the first embodiment in that pluralities of through holes 71D, 72D formed respectively in the first and second sleeves 71, 72 serve as the supply/discharge ports connecting the first and second valve chambers 81, 82 to the first and second cylinder passages 91, 92. With the cylinder control device 200, therefore, hunting can be prevented without modifying the sleeves even when a greater external force than the envisaged external force acts on the cylinder.

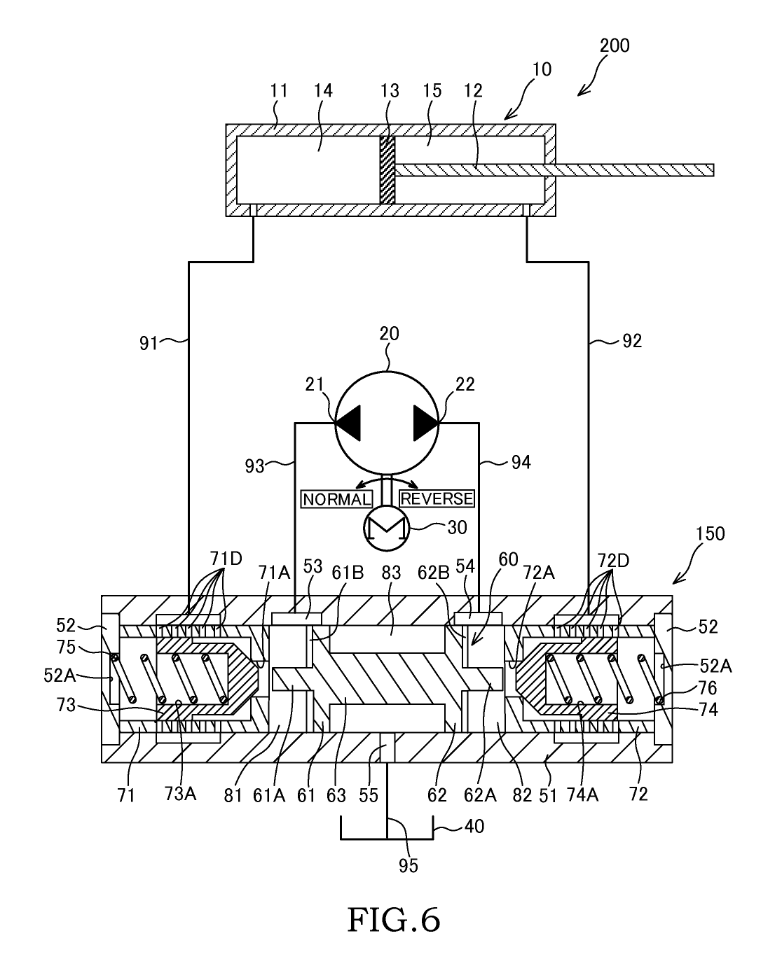

Referring to FIGS. 5 and 6, a configuration of the cylinder control device 200 will now be described.

As shown in FIGS. 5 and 6, the through holes 71D are formed in the side wall of the first sleeve 71 as supply/discharge ports communicating with the first cylinder passage 91. The through holes 71D communicate with the first cylinder chamber 14 via the first cylinder passage 91.

The through holes 71D are formed in the side wall of the first sleeve 71 so as to be arranged in the sliding direction of the first valve body 73. When the first valve body 73 slides through the first sleeve 71, the through holes 71D open and close such that a number of open through holes 71D varies in accordance with the sliding position of the first valve body 73, and as a result, the resistance that is applied to the working oil passing through the through holes 71D as a whole is varied. The through holes 71D are formed such that the number of open through holes 71D reaches a maximum when the first valve body 73 is at the maximum movement position (the second position). In other words, when the first valve body 73 is at the maximum movement position, the number of through holes 71D through which the working oil passes is at a maximum. When the first valve body 73 is biased by the first spring 75 from the maximum movement position such that the sliding position thereof varies in the rightward direction of the figures, a part of the through holes 71D is closed, and as a result, resistance corresponding to the sliding position of the first valve body 73 is applied to the working oil passing through.

The through holes 72D are formed in the side wall of the second sleeve 72 as supply/discharge ports communicating with the second cylinder passage 92. The through holes 72D communicate with the second cylinder chamber 15 via the second cylinder passage 92.

The through holes 72D are formed in the side wall of the second sleeve 72 so as to be arranged in the sliding direction of the second valve body 74. When the second valve body 74 slides through the second sleeve 72, the through holes 72D open and close such that a number of open through holes 72D varies in accordance with the sliding position of the second valve body 74, and as a result, the resistance that is applied to the working oil passing through the through holes 72D as a whole is varied. The through holes 72D are formed such that the number of open through holes 72D reaches a maximum when the second valve body 74 is at the maximum movement position. In other words, when the second valve body 74 is at the maximum movement position, the number of through holes 72D through which the working oil passes is at a maximum. When the second valve body 74 is biased by the second spring 76 from the maximum movement position such that the sliding position thereof varies in the leftward direction of the figures, a part of the through holes 72D is closed, and as a result, resistance corresponding to the sliding position of the second valve body 74 is applied to the working oil passing through.

The number, diameter, arrangement interval, shape, and so on of the through holes 71D, 72D may be set as desired as long as the number of open through holes 71D, 72D is as a maximum when the first and second valve bodies 73, 74 are at the second position, and the number of open through holes 71D, 72D is reduced as the first and second valve bodies 73, 74 slide due to be biased by the first and second springs 75, 76. In this embodiment, as shown in FIGS. 5 and 6, five through holes 71D and five through holes 72D are formed. Further, the through holes 71D, 72D are formed so as to be arranged in the respective sliding directions of the first and second valve bodies 73, 74, and may be formed in pluralities in respective circumferential directions of the first and second sleeves 71, 72.

Next, referring to FIGS. 6 to 8, operation control performed on the cylinder 10 by the cylinder control device 200 will be described. A case in which the drive motor 30 is stopped so that the pump 20 is out of operation is similar to the first embodiment, and therefore description thereof has been omitted.

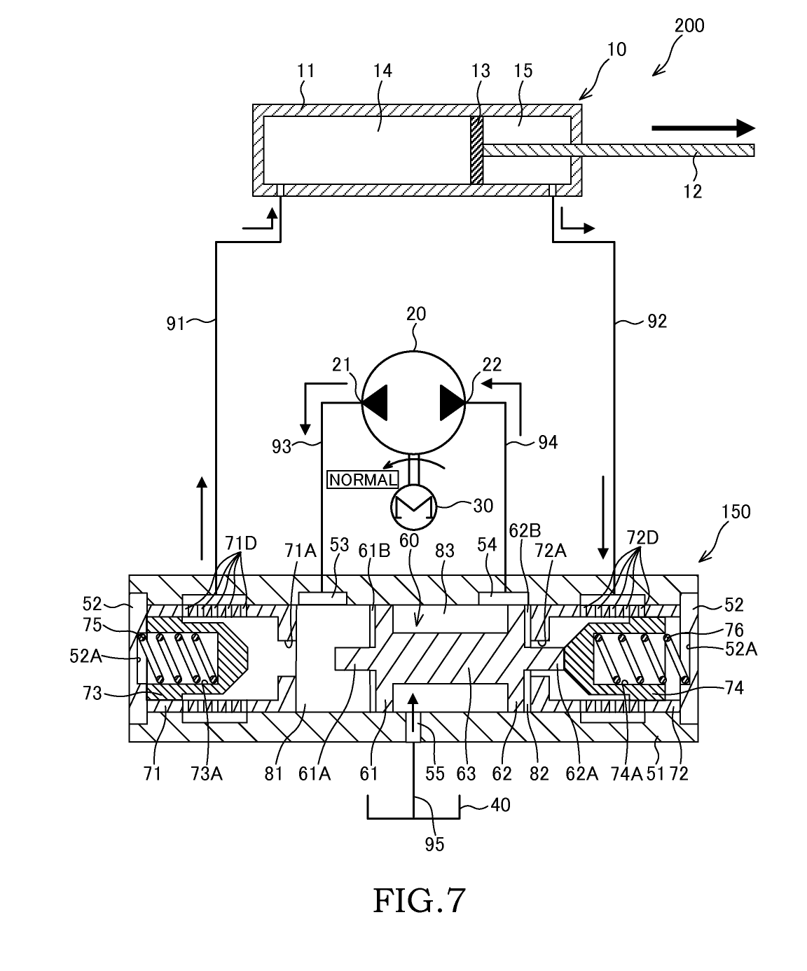

As shown in FIG. 7, to cause the cylinder 10 to expand, the drive motor 30 is rotated normally so that the first valve body 73 is pushed down to the maximum movement position (the second position) in which the open end thereof is brought into contact with the lid member 52 by the oil pressure in the first valve chamber 81. When the first valve body 73 is pushed down to the maximum movement position, the through holes 71D open such that the number of open through holes 71D reaches the maximum. In other words, when the first valve body 73 moves to the maximum movement position in which the first spring 75 is compressed from the midway position (the first position) in which a part of the through holes 71D is closed, the communicating port 71A of the first sleeve 71 communicates with the through holes 71D that are open in the maximum number. Hence, when the first valve body 73 is opened by the oil pressure in the first valve chamber 81, the working oil is allowed to flow from the first valve chamber 81 toward the first cylinder chamber 14.

Similarly to the first embodiment, when the drive motor 30 rotates normally, the spool 60 moves in a rightward direction of FIG. 7 from the neutral position (see FIG. 6) toward the second sleeve 72 so that the second projecting shaft 62A of the spool 60 contacts the end surface of the second valve body 74. As a result, the second valve body 74 opens.

The spool 60 moves until the second piston portion 62 contacts the second sleeve 72. Accordingly, the second valve body 74 is pushed down by the second projecting shaft 62A of the spool 60, which contacts the second sleeve 72, against the biasing force of the second spring 76 to the midway position (the first position) in which a part of the through holes 72D is closed. When the second valve body is moved to the midway position in this manner, the communicating port 72A into which the second projecting shaft 62A is inserted communicates with the through holes 72D that are partially closed by the second valve body 74 at the midway position.

When the through holes 72D are partially closed by the second valve body 74, resistance corresponding to the sliding position of the second valve body 74 is applied to the working oil passing through the through holes 72D. As a result, a reduction in the pressure in the second cylinder chamber 15 is suppressed.

Here, when the external force acting on the cylinder 10 in the expansion direction is small, rapid expansion of the piston rod 12 is prevented by the pressure in the second cylinder chamber 15, which is prevented from decreasing by the second valve body 74 at the midway position. Therefore, the pressure in the first cylinder chamber 14 and the first valve chamber 81 does not decrease, and the spool 60 contacting the second sleeve 72 does not move toward the neutral position. In other words, when the external force acting on the cylinder 10 is small, the communicating port 72A into which the second projecting shaft 62A is inserted communicates with the through holes 72D that are partially closed by the second valve body 74 at the midway position.

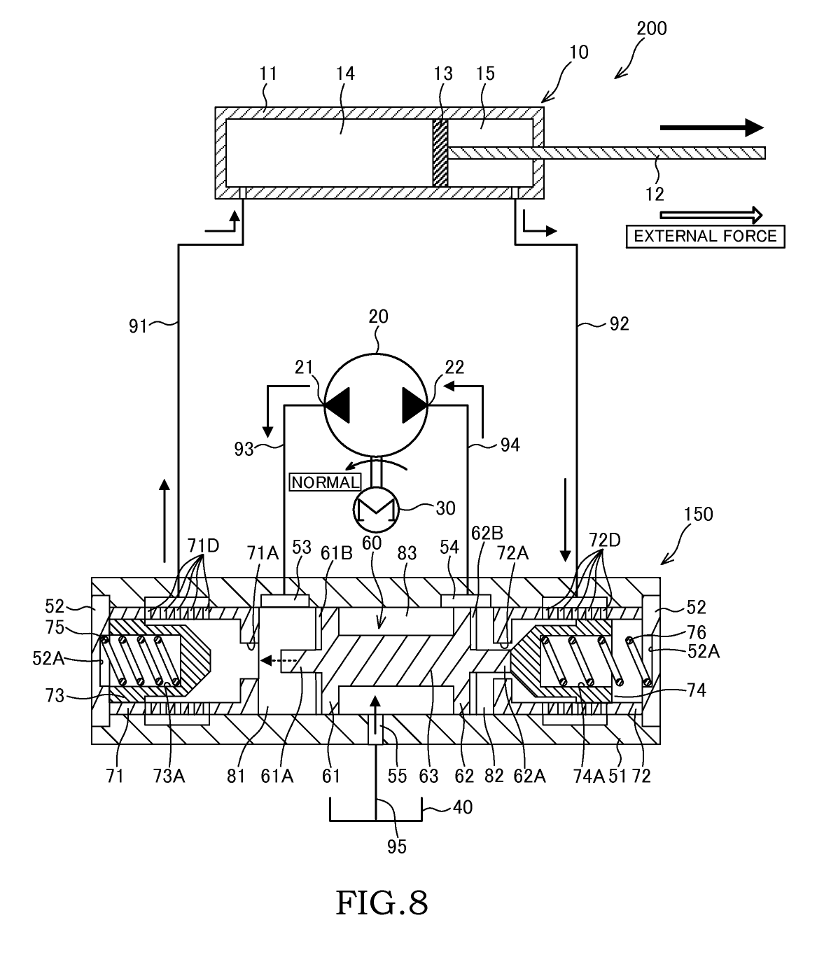

When the external force acting on the cylinder 10 increases beyond a certain value (a reference value), the pressure in the second cylinder chamber 15, which is prevented from decreasing by the second valve body 74 at the midway position shown in FIG. 7, is no longer sufficient to prevent the piston rod 12 from expanding rapidly. When the piston rod 12 expands rapidly, the pressure in the first cylinder chamber 14 and the first valve chamber 81 decreases. When the pressure in the first valve chamber 81 decreases, sufficient pressure for bringing the spool 60 into contact with the second sleeve 72 against the biasing force of the second spring 76 can no longer be secured, and therefore the spool 60 moves in the leftward direction of the figure toward the neutral position, as shown by a dotted line arrow in FIG. 8.

As shown in FIG. 8, as the spool 60 moves toward the neutral position, the second valve body 74 is moved in the leftward direction of the figure by the biasing force of the second spring 76. When the second valve body 74 moves in the leftward direction of the figure, a part of the through holes 72D is gradually closed by the second valve body 74, and therefore the number of open through holes 72D is gradually reduced. Accordingly, the resistance applied to the fluid passing through the through holes 72D increases such that the pressure in the second cylinder chamber 15 becomes larger than when the second valve body 74 is at the midway position.

The increased pressure in the second cylinder chamber 15 forms resistance against rapid expansion of the piston rod 12 caused by the external force exceeding the reference value, and therefore a reduction in the pressure in the first cylinder chamber 14 is suppressed so that the movement of the spool 60 toward the neutral position is impaired. Once the number of open through holes 72D has been reduced to a certain extent, the piston rod 12 no longer expands in response to the external force, and therefore the pressure in the first valve chamber 81 stops decreasing. As a result, the pressure in the first valve chamber 81 recovers, and the spool 60 stops moving toward the neutral position.

After the spool 60 has stopped moving toward the neutral position, the spool 60 starts to move again in the rightward direction of the figure against the biasing force of the second spring 76, eventually coming into contact with the second sleeve 72, as shown in FIG. 7.

Even in a case where the external force acting on the cylinder is larger than the reference value, the working oil in the second cylinder chamber 15 is discharged to the second valve chamber 82 side through the second cylinder passage 92, the through holes 72D, a part of which is closed, and the communicating port 72A when the second valve body 74 is pushed open by the spool 60. Hence, the second valve body 74, when pushed by the spool 60, opens the through holes 72D in a smaller number than that of the through holes 71D, which are opened with the maximum number by the first valve body 73, and as a result, the working oil is allowed to flow from the second cylinder chamber 15 toward the second valve chamber 82.

When the working oil is supplied to the first cylinder chamber 14 and discharged from the second cylinder chamber 15 in the manner described above, the piston rod 12 moves in the expansion direction, and as a result, the cylinder 10 expands.

When the cylinder 10 expands, the working oil in the first valve chamber 81 is supplied to the first cylinder chamber 14 through the through holes 71D open in the maximum number. The working oil discharged from the second cylinder chamber 15, meanwhile, is led to the second valve chamber 82 side through the partially closed through holes 72D that are open in a reduced number so as to apply resistance to the fluid passing through. Hence, resistance is applied to the discharged working oil even when an external force acts on the piston rod 12 in the expansion direction, thereby suppressing a reduction in the pressure in the discharge side second cylinder chamber 15, and as a result, the cylinder 10 does not expand rapidly. Accordingly, the oil pressure in the first cylinder chamber 14 and the first valve chamber 81 does not decrease rapidly during expansion of the cylinder 10, and therefore the spool 60 can be prevented from returning to the neutral position. The spool 60 can therefore be stability biased by the oil pressure in the first valve chamber 81 so as to move in the rightward direction of the figure toward the second sleeve 72, whereby the second valve body 74 can be held at the midway position. Hence, a communication state can be maintained between the communicating port 72A and the through holes 72D, and as a result, hunting can be prevented from occurring during expansion of the cylinder 10.

Furthermore, even in a case where the external force acting on the cylinder 10 is larger than the reference value so that the spool 60 and the second valve body 74 move toward the neutral position, the second valve body 74 gradually closes a part of the through holes 72D while moving so that the resistance applied to the working oil passing through the through holes 72D gradually increases. As a result, the spool 60 can be prevented from returning to the neutral position. Hence, even when the external force acting on the cylinder 10 is larger than the reference value, the communication state between the communicating port 72A and the through holes 72D can be maintained, and as a result, hunting can be prevented from occurring during expansion of the cylinder 10.

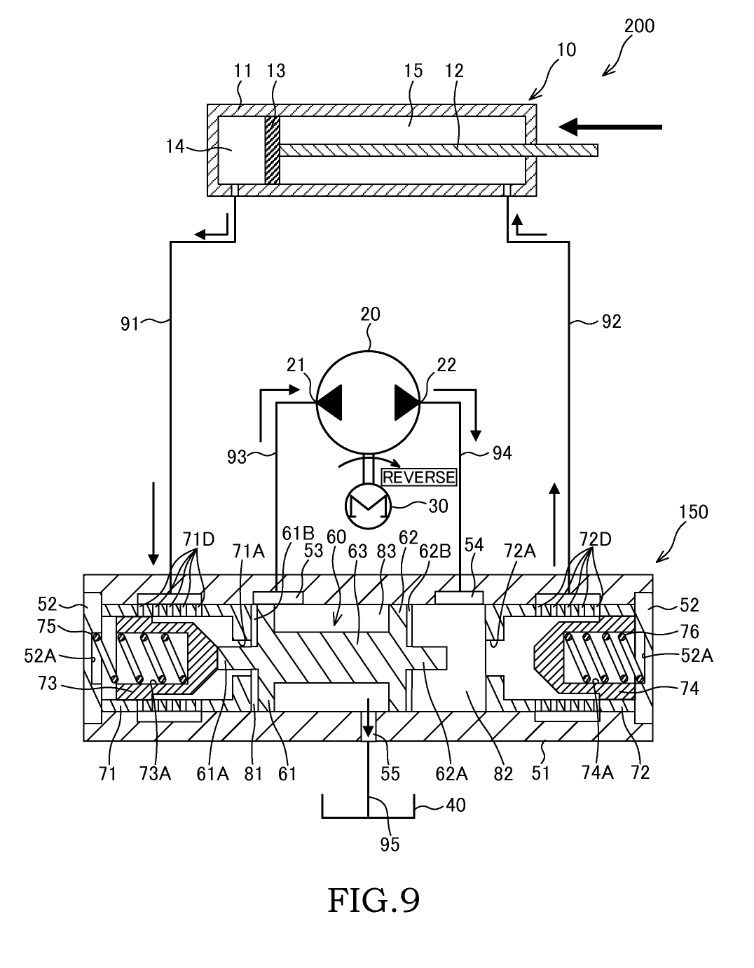

As shown in FIG. 9, to cause the cylinder 10 to contract, the drive motor 30 is rotated in reverse so that, similarly to the first embodiment, the second valve body 74 is pushed down to the maximum movement position (the second position) in which the open end thereof is brought into contact with the lid member 52 by the oil pressure in the second valve chamber 82. When the second valve body 74 is pushed down to the maximum movement position, the through holes 72D open such that the number of open through holes 72D reaches the maximum. In other words, when the second valve body 74 moves to the maximum movement position (the second position) on the outside of the midway position (the first position), the communicating port 72A of the second sleeve 72 communicates with the through holes 72D that are open in the maximum number. Hence, when the second valve body 74 is opened by the oil pressure in the second valve chamber 82, the working oil is allowed to flow from the second valve chamber 82 toward the second cylinder chamber 15.

Similarly to the first embodiment, when the drive motor 30 rotates in reverse, the spool 60 moves in the leftward direction of the figure from the neutral position (see FIG. 6) toward the first sleeve 71 so that the first projecting shaft 61A of the spool 60 contacts the end surface of the first valve body 73. As a result, the first valve body 73 opens.

The spool 60 moves until the first piston portion 61 contacts the first sleeve 71. Accordingly, the first valve body 73 is pushed down against the biasing force of the first spring 75 to the midway position (the first position) in which a part of the through holes 71D is closed. When the first valve body 73 is moved to the midway position in this manner, the communicating port 71A into which the first projecting shaft 61A is inserted communicates with the through holes 71D that are partially closed by the first valve body 73 at the midway position.

When the through holes 71D are partially closed by the first valve body 73, resistance corresponding to the sliding position of the first valve body 73 is applied to the working oil passing through the through holes 71D. As a result, a reduction in the pressure in the first cylinder chamber 14 is suppressed.

When the external force acting on the cylinder 10 is equal to or smaller than the reference value, rapid contraction of the piston rod 12 is prevented in accordance with a similar principle to a case in which the cylinder 10 expands, and therefore the communicating port 71A into which the first projecting shaft 61A is inserted communicates with the through holes 71D, a part of which is closed.

When the external force acting on the cylinder 10 is larger than the reference value, the pressure in the second valve chamber 82 decreases in accordance with a similar principle to a case in which the cylinder 10 expands, and as a result, the spool 60 moves in the rightward direction of the figure toward the neutral position.

A part of the through holes 71D is gradually closed as the first valve body 73 moves in response to the movement of the spool 60, and therefore the resistance applied to the fluid passing through the through holes 71D gradually increases such that the pressure in the first cylinder chamber 14 becomes larger than when the first valve body 73 is at the midway position.

Rapid expansion of the piston rod 12 is prevented by the pressure increase in the first cylinder chamber 14, and as a result, the first valve body 73 stops moving toward the neutral position.

Even in a case where the external force acting on the cylinder is larger than the reference value, the working oil in the first cylinder chamber 14 is discharged to the first valve chamber 81 side through the first cylinder passage 91, the through holes 71D, a part of which is closed, and the communicating port 71A when the first valve body 73 is pushed open by the spool 60. Hence, the first valve body 73, when pushed by the spool 60, opens the through holes 72D in a smaller number than that of the through holes 71D, which are opened with the maximum number by the second valve body 74, and as a result, the working oil is allowed to flow from the first cylinder chamber 14 toward the first valve chamber 81.

When the working oil is supplied to the second cylinder chamber 15 and discharged from the first cylinder chamber 14 in the manner described above, the piston rod 12 moves in the contraction direction, and as a result, the cylinder 10 contracts.

When the cylinder 10 contracts, the working oil in the second valve chamber 82 is supplied to the second cylinder chamber 15 through the through holes 72D in the second sleeve 72, the maximum number of which is open. The working oil discharged from the first cylinder chamber 14, meanwhile, is led to the first valve chamber 81 side through the partially closed through holes 71D that are open in a reduced number so that resistance is applied to the fluid passing through. Hence, resistance is applied to the discharged working oil even when an external force acts on the piston rod 12 in the contraction direction, thereby suppressing a reduction in the pressure in the discharge side first cylinder chamber 14, and as a result, the cylinder 10 does not contract rapidly. Accordingly, the oil pressure in the second cylinder chamber 15 and the second valve chamber 82 does not decrease rapidly during contraction of the cylinder 10, and therefore the spool 60 can be prevented from returning to the neutral position. The spool 60 can therefore be stability biased by the oil pressure in the second valve chamber 82 so as to move in the leftward direction of the figure toward the first sleeve 71, whereby the first valve body 73 can be held at the midway position. Hence, a communication state between the communicating port 71A and the through holes 71D can be maintained, and as a result, hunting can be prevented from occurring during contraction of the cylinder 10.

Furthermore, even in a case where the external force acting on the cylinder 10 is larger than the reference value so that the spool 60 and the first valve body 73 move toward the neutral position, the first valve body 73 gradually closes a part of the through holes 71D while moving so that the resistance applied to the working oil passing through the through holes 71D gradually increases. As a result, the spool 60 can be prevented from returning to the neutral position. Hence, even when the external force acting on the cylinder 10 is larger than the reference value, the communication state between the communicating port 71A and the through holes 71D can be maintained, and as a result, hunting can be prevented from occurring during contraction of the cylinder 10.

With the cylinder control device 200, therefore, resistance is applied to the working oil discharged from one of the first and second cylinder chambers 14, 15 while passing through the partially closed through holes 71D or 72D, and as a result, a reduction in the pressure in the discharge side cylinder chamber is suppressed. By suppressing a reduction in the pressure in the discharge side cylinder chamber, rapid expansion and contraction of the piston rod 12 caused by an external force acting in an identical direction to the expansion/contraction direction is prevented. Accordingly, a situation in which the pressure in the valve chamber on the side to which the working oil is supplied decreases due to rapid expansion and contraction of the piston rod 12, causing the spool 60 to move to the neutral position, does not occur. As a result, hunting occurring when the cylinder 10 expands and contracts can be prevented.

When the external force acting on the cylinder 10 in the same direction as the expansion/contraction direction is large such that the first and second valve bodies 73, 74 pushed down by the spool 60 move to the neutral position, a part of the through holes 71D, 72D through which the working oil discharged from the cylinder 10 passes is gradually closed by the moving first and second valve bodies 73, 74. Accordingly, the resistance applied to the working oil discharged from the cylinder 10 gradually increases. A reduction in the pressure in the discharge side cylinder chamber is therefore further suppressed, whereby a reduction in the pressure in the supply side valve chamber due to rapid expansion and contraction of the piston rod 12 is suppressed. Accordingly, the spool 60 and the first and second valve bodies 73, 74 stop moving toward the neutral position, and therefore the first and second valve bodies 73, 74 do not completely close the communicating ports 71A, 72A. Hence, even in a case where the external force acting on the cylinder 10 in the same direction as the expansion/contraction direction is large, hunting occurring when communication between the through holes 71D, 72D and the communicating ports 71A, 72A is blocked by movement of the first and second valve bodies 73, 74 can be prevented.

According to the second embodiment, described above, following effects are obtained.

A control valve 150 of the cylinder control device 200 uses the first valve body 73, which controls the communication state between the communicating port 71A and the through holes 71D of the first sleeve 71 using the oil pressure in the first valve chamber 81 or the pushing force from the first projecting shaft 61A of the spool 60, and the second valve body 74, which controls the communication state between the communicating port 72A and the through holes 72D of the second sleeve 72 using the oil pressure in the second valve chamber 82 or the pushing force from the second projecting shaft 62A of the spool 60, to control the flow of working oil between the cylinder 10 and the pump 20 and prevent hunting during expansion and contraction of the cylinder 10.

The control valve 150 is configured to function as both the operation check valve that controls the flow of working oil between the cylinder and the pump and the slow return valve that prevents hunting during expansion and contraction of the cylinder in the conventional cylinder control device, and therefore reductions can be achieved in the number of constituent components of the cylinder control device 200 and the number of processes required to assemble the cylinder control device 200.

Further, the control valve 150 is configured to switch the flow of working oil between the pump 20 and the tank 40 in accordance with the sliding position of the spool 60, and therefore functions as the switch valve of the conventional cylinder control device. As a result, further reductions can be achieved in the number of constituent components of the cylinder control device 200 and the number of processes required to assemble the cylinder control device 200.

Moreover, the control valve 150 varies the resistance applied to the fluid passing through the through holes 71D, 72D formed respectively in the first and second sleeves 71, 72 in accordance with the sliding position of the spool 60, and can therefore prevent hunting even in a case where the external force acting on the cylinder 10 varies. In other words, even when the envisaged external force differs in each cylinder 10, there is no need to use different first and second sleeves 71, 72, and identical sleeves may be used. As a result, a number of provided sleeves can be reduced. Accordingly, erroneous attachment of the sleeves can be prevented, and a manufacturing cost of the cylinder control device 200 can be reduced.

### Third Embodiment

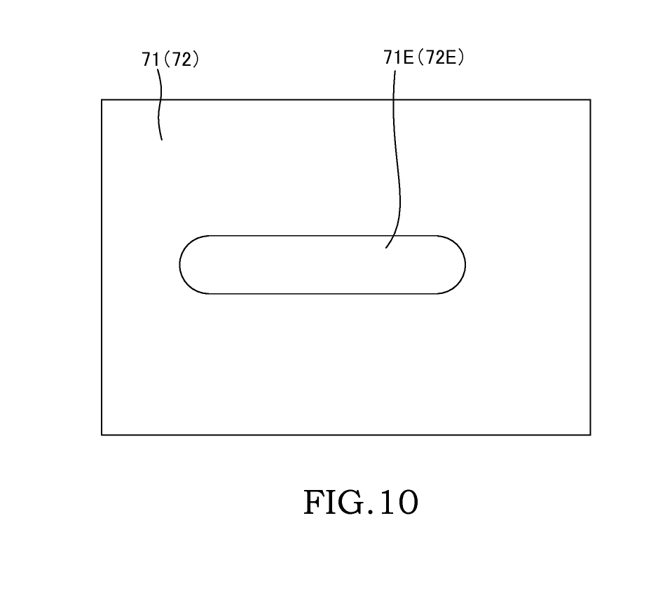

Next, referring to FIGS. 10 to 12, a cylinder control device 300 according to a third embodiment of this invention will be described. The following description focuses on differences with the second embodiment. Identical configurations to the cylinder control device 200 according to the second embodiment have been allocated identical reference symbols, and description thereof has been omitted.

In the cylinder control device 200 according to the second embodiment, described above, the pluralities of through holes 71D, 72D formed respectively in the first and second sleeves 71, 72 serve as the supply/discharge ports connecting the first and second valve chambers 81, 82 to the first and second cylinder passages 91, 92. The pluralities of through holes 71D, 72D are configured such that as the first and second valve bodies 73, 74 slide due to be biased by the first and second springs 75, 76, the number of open through holes 71D, 72D is reduced, leading to an increase in the resistance applied to the fluid passing through.

The cylinder control device 300 differs from the cylinder control device 200 according to the second embodiment in that slits 71E, 72E formed respectively in the first and second sleeves 71, 72 serve as the supply/discharge ports connecting the first and second valve chambers 81, 82 to the first and second cylinder passages 91, 92. With the cylinder control device 300, similarly to the cylinder control device 200 according to the second embodiment, hunting can be prevented without modifying the sleeves even when the envisaged external force differs in each cylinder.

A configuration of the cylinder control device 300 will be described below.

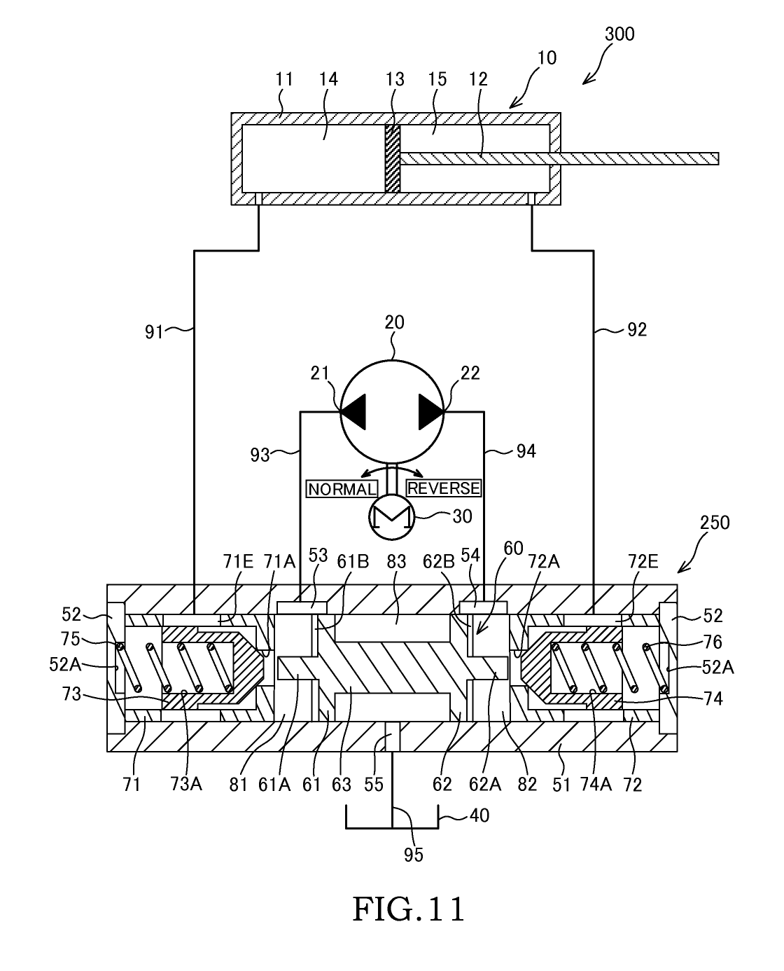

As shown in FIGS. 10 and 11, the slit 71E is formed in the side wall of the first sleeve 71 as a supply/discharge port communicating with the first cylinder passage 91. The slit 71E communicates with the first cylinder chamber 14 via the first cylinder passage 91.

The slit 71E is formed in the side wall of the first sleeve 71 so as to extend in the sliding direction of the first valve body 73. When the first valve body 73 slides through the first sleeve 71, the slit 71E opens and closes such that an opening area thereof varies in accordance with the sliding position of the first valve body 73, and as a result, the resistance that is applied to the working oil passing through the slit 71E is varied. The slit 71E is formed such that the opening area thereof reaches a maximum when the first valve body 73 is at the maximum movement position. In other words, when the first valve body 73 is at the maximum movement position, the opening area of the slit 71E through which the working oil passes is at a maximum. When the first valve body 73 is biased by the first spring 75 from the maximum movement position such that the sliding position thereof varies in the rightward direction of the figure, an open part of the slit 71E is closed such that the opening area is reduced, and as a result, resistance corresponding to the sliding position of the first valve body 73 is applied to the working oil passing through.

The slit 72E is formed in the side wall of the second sleeve 72 as a supply/discharge port communicating with the second cylinder passage 92. The slit 72E communicates with the second cylinder chamber 15 via the second cylinder passage 92.

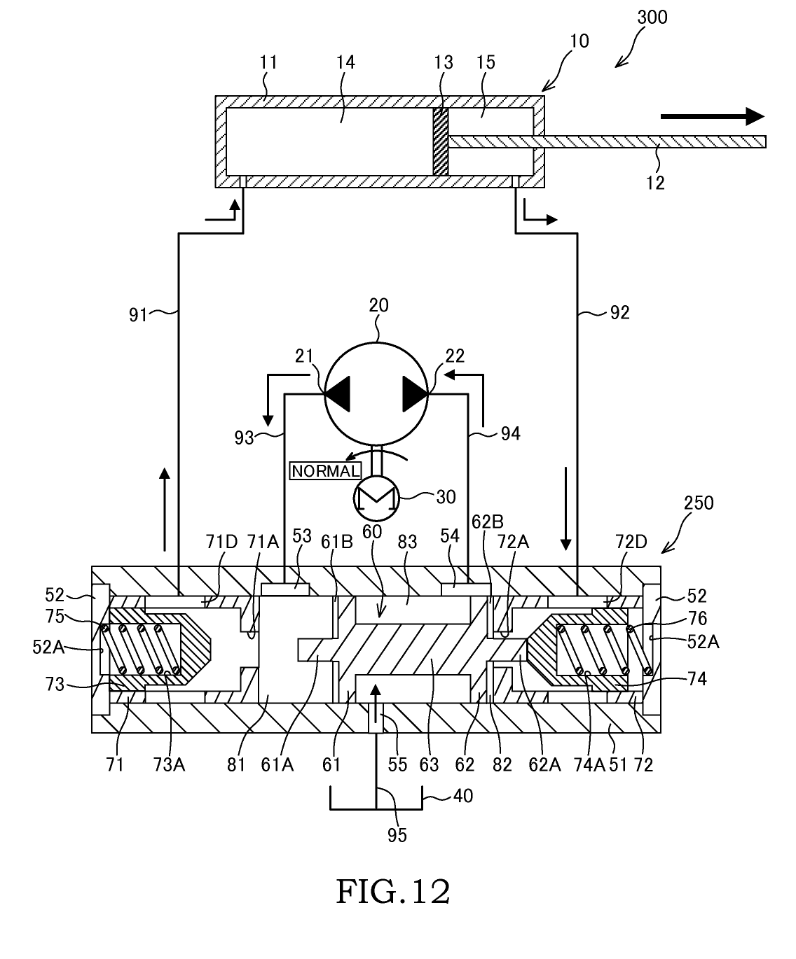

The slit 72E is formed in the side wall of the second sleeve 72 so as to extend in the sliding direction of the second valve body 74. When the second valve body 74 slides through the second sleeve 72, the slit 72E opens and closes such that an opening area thereof varies in accordance with the sliding position of the second valve body 74, and as a result, the resistance that is applied to the fluid passing through the slit 72E is varied. The slit 72E is formed such that the opening area thereof reaches a maximum when the second valve body 74 is at the maximum movement position. In other words, when the second valve body 74 is at the maximum movement position, the opening area of the slit 72E through which the working oil passes is at a maximum. When the second valve body 74 is biased by the second spring 76 from the maximum movement position such that the sliding position thereof varies in the leftward direction of the figure, a part of the slit 72E is closed such that the opening area is reduced, and as a result, resistance corresponding to the sliding position of the second valve body 74 is applied to the working oil passing through (see FIG. 12).

A width, a length, a shape, and so on of the slits 71E, 72E may be set as desired as long as the opening area thereof is at a maximum when the first and second valve bodies 73, 74 are at the maximum movement position and the opening area is reduced as the first and second valve bodies 73, 74 slide from the maximum movement position due to be biased by the first and second springs 75, 76.

Hence, in the cylinder control device 300 including the slits 71E, 72E, the opening area reduces as the first and second valve bodies 73, 74 slide from the maximum movement position due to be biased by the first and second springs 75, 76, whereby the resistance applied to the working oil passing through increases. Therefore, similarly to the cylinder control device 200 according to the second embodiment, which includes the pluralities of through holes 71D, 72D respectively connecting the first and second valve chambers 81, 82 to the first and second cylinder passages 91, 92, hunting can be prevented without modifying the sleeves even when the envisaged external force differs in each cylinder 10.

According to the third embodiment, described above, following effects are obtained in addition to similar effects to those of the second embodiment.

A control valve 250 of the cylinder control device 300 includes the slits 71E, 72E as the supply/discharge ports respectively connecting the first and second valve chambers 81, 82 to the first and second cylinder passages 91, 92. The slits 71E, 72E can be formed with a smaller number of processes, and therefore more easily, than that of the pluralities of through holes 71D, 72D. As a result, a manufacturing cycle can be shortened and the manufacturing cost can be reduced.

### Fourth Embodiment

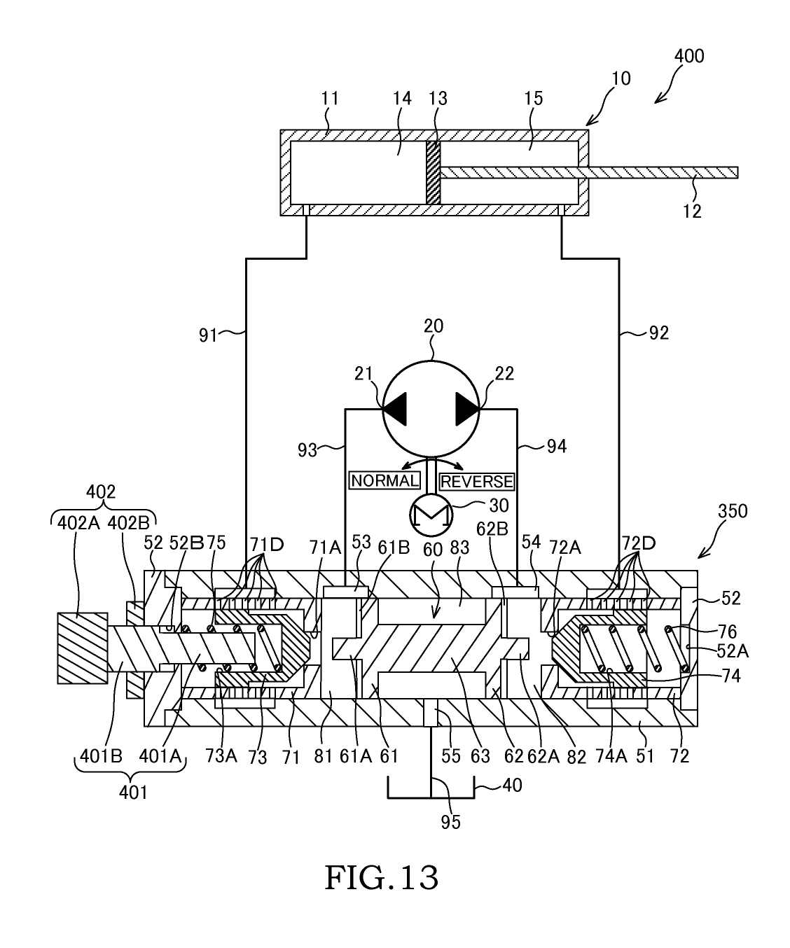

Next, referring to FIGS. 13 to 17, a cylinder control device 400 according to a fourth embodiment of this invention will be described. The following description focuses on differences with the second embodiment. Identical configurations to the cylinder control device 200 according to the second embodiment have been allocated identical reference symbols, and description thereof has been omitted.

In the cylinder control device 200 according to the second embodiment, described above, when the first valve body 73 is moved by the oil pressure in the first valve chamber 81, the first valve body 73 moves until it comes into contact with the lid member 52. In the second embodiment, a position at which the first valve body 73 contacts the lid member 52 serves as the maximum movement position (the second position).

The cylinder control device 400 differs from the cylinder control device 200 according to the second embodiment in that the maximum movement position (the second position) of the first valve body 73 can be adjusted.

A configuration of the cylinder control device 400 will now be described below.

As shown in FIG. 13, the cylinder control device 400 includes a stopper 401 restricting sliding of the first valve body 73 in a compression direction of the first spring 75 serving as a biasing member, and an adjusting mechanism 402 being capable of adjusting the position of the stopper 401.

The stopper 401 includes a columnar contact portion 401A, a part of which is inserted into the first sleeve 71 to be capable of contacting the first valve body 73, and a screw portion 401B that is screwed to a female screw portion 52B of the lid member 52.

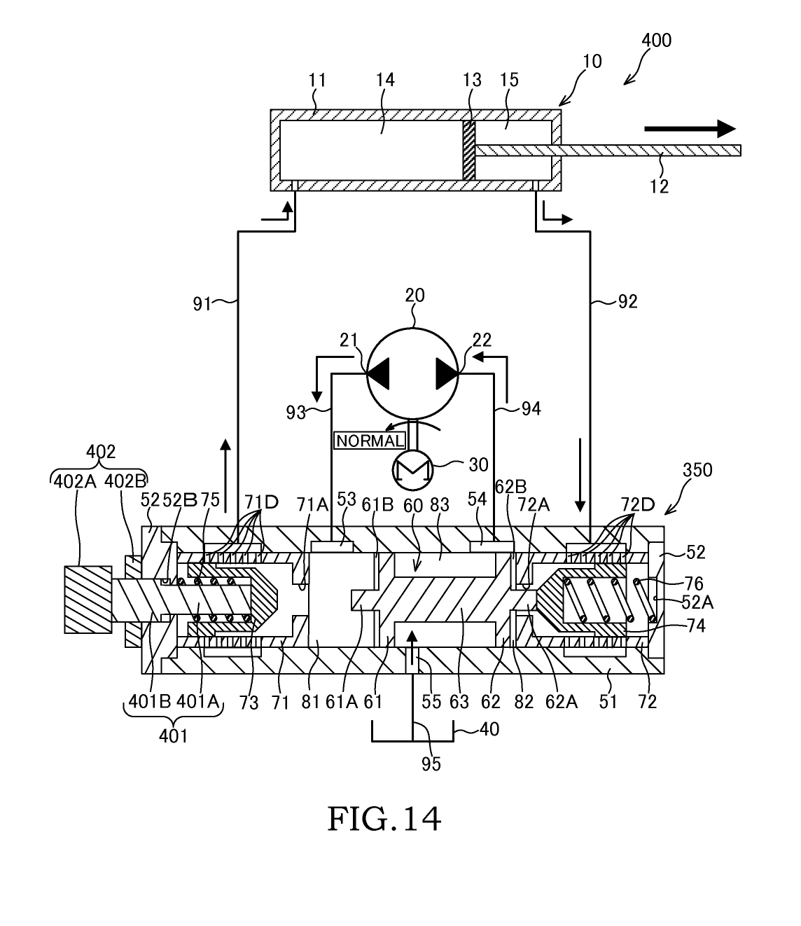

The contact portion 401A is inserted into an inner side of the first spring 75 housed in the first sleeve 71. As shown in FIG. 14, the contact portion 401A is formed to be capable of contacting the hole bottom of the housing hole 73A in the first valve body 73 before the end surface of the first valve body 73 contacts the lid member 52 when the first valve body 73 moves against the biasing force of the first spring 75.

Since the contact portion 401A is inserted into the inner side of the first spring 75, the first spring 75 is supported by the contact portion 401A. Hence, there is no need to form the spring housing hole 52A in the lid member 52.

The screw portion 401B is a columnar member having a male screw formed on an outer peripheral surface thereof, and is screwed to the female screw portion 52D formed in the lid member 52. One end of the screw portion 401B is connected to the contact portion 401A, and another end is formed to extend to an outer side of the lid member 52.

The adjusting mechanism 402 includes an operating portion 402A connected to the screw portion 401B of the stopper 401, and a fixing portion 402B configured to fix the position of the stopper 401.

The operating portion 402A is a columnar knob connected to an end portion of the screw portion 401B of the stopper 401 on the outer side of the lid member 52. When the operating portion 402A is rotated, the screw portion 401B of the stopper 401 rotates, and as a result, a screwing position between the female screw portion 52B of the lid member 52 and the screw portion 401B of the stopper 401 can be adjusted. Hence, by rotating the operating portion 402A, the stopper 401 is moved in the sliding direction of the first valve body 73. As a result, a position of the contact portion 401A of the stopper 401 within the first sleeve, or in other words a position in which the contact portion 401A contacts the first valve body 73, can be adjusted.

The fixing portion 402B is a nut 402B that is disposed between the lid member 52 and the operating portion 402A and screwed to the screw portion 401B of the stopper 401 on an inner periphery thereof. By tightening the nut 402B to the lid member 52, the screw fastening between the female screw portion 52B of the lid member 52 and the screw portion 401B of the stopper 401 is prevented from coming loose. In other words, by tightening the nut 402B to the lid member 52, the stopper 401 is prevented from moving in the sliding direction of the first valve body 73, and therefore the stopper 401 can be fixed in position.

To adjust the position of the stopper 401, the nut 402B is loosened and the operating portion 402A is rotated to move the stopper 401 to a desired position, whereupon the nut 402B is tightened to the lid member 52 again. By adjusting the position of the stopper 401 to a desired position in this manner, the maximum movement position of the first valve body 73 can be set.

Next, referring to FIGS. 14 to 17, control performed by the cylinder control device 400 to adjust the maximum movement position (the second position) of the first valve body 73 will be described. Basic operations for controlling expansion and contraction of the cylinder 10 are similar to those of the first to third embodiments, and therefore description thereof has been omitted.

First, a case in which the drive motor 30 is rotated normally so that the first valve body 73 is moved in a leftward direction of the figure by the oil pressure in the first valve chamber 81 will be described.

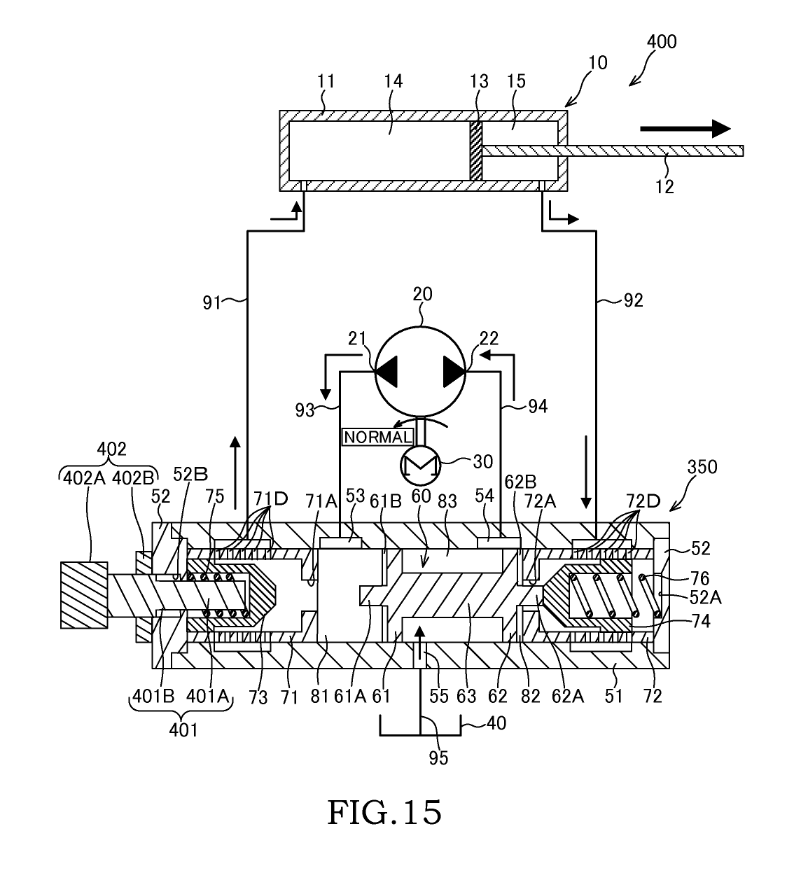

As shown in FIG. 15, when the position of the stopper 401 is set in a maximally retreated positioned relative to the first valve body 73, and the first valve body 73 is moved by oil pressure in the leftward direction of the figure against the biasing force of the first spring 75, the first valve body 73 contacts the lid member 52 before contacting the contact portion 401A of the stopper 401. Accordingly, the position in which the first valve body 73 contacts the lid member 52 serves as the maximum movement position of the first valve body 73.

In this case, similarly to the second embodiment, the maximum number (five in this embodiment) of the through holes 71D in the first sleeve 71 are opened. As a result, minimum resistance is applied to the working oil supplied to the first cylinder chamber 14, and therefore the piston rod 12 expands at a maximum speed.

When the position of the stopper 401 is advanced from the maximally retreated position shown in FIG. 15 toward the first valve body 73, as shown in FIG. 14, and the first valve body 73 is moved by oil pressure in the leftward direction of the figure against the biasing force of the first spring 75, the first valve body 73 contacts the contact portion 401A of the stopper 401 before contacting the lid member 52. Accordingly, the position in which the first valve body 73 contacts the contact portion 401A of the stopper 401 serves as the maximum movement position of the first valve body 73.

In this case, four of the through holes 71D in the first sleeve 71, i.e. a smaller number than the maximum number (five), are opened such that resistance is applied to the working oil supplied from the first valve chamber 81 to the first cylinder chamber 14. As a result, resistance is applied to the working oil supplied to the first cylinder chamber 14, and therefore the expansion speed of the piston rod 12 decreases.

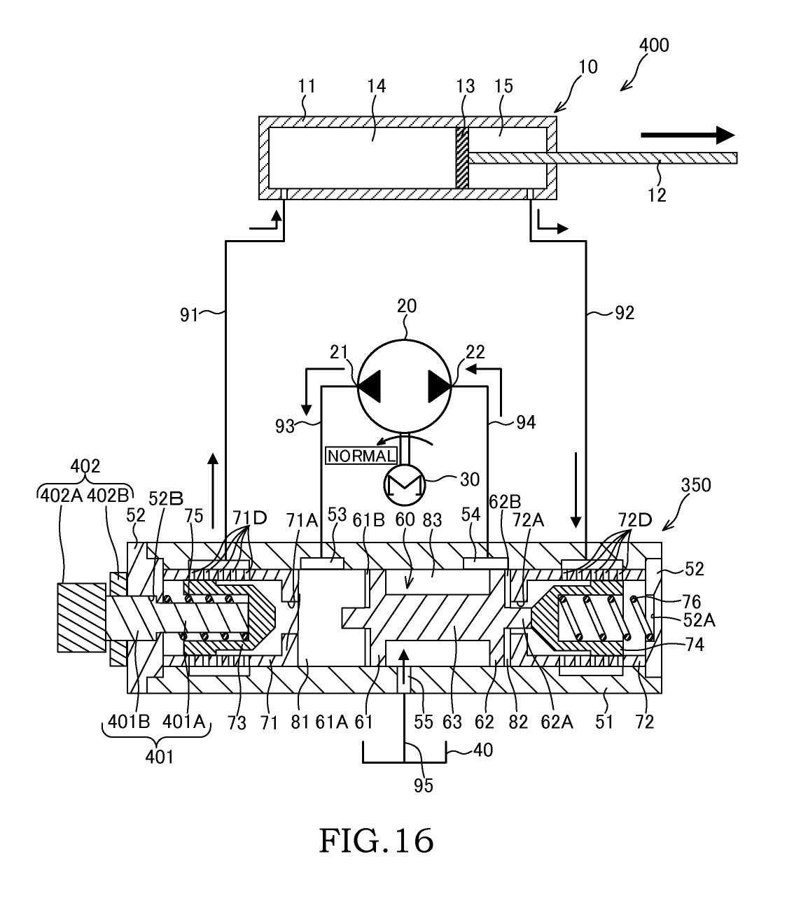

When, as shown in FIG. 16, the position of the stopper 401 is set in a maximally advanced positioned relative to the first valve body 73 from the position shown in FIG. 14, the first valve body 73 contacts the contact portion 401A of the stopper 401 in a position where a sliding amount of the first valve body 73 against the biasing force of the first spring 75 is at a minimum. Accordingly, the position in which the first valve body 73 contacts the contact portion 401A of the stopper 401 after sliding against the biasing force of the first spring 75 by the minimum amount serves as the maximum movement position of the first valve body 73.

In this case, three of the through holes 71D in the first sleeve 71, i.e. a minimum number, are opened. As a result, maximum resistance is applied to the working oil supplied to the first cylinder chamber 14, and therefore the piston rod 12 expands at a minimum speed.

The second valve body 74, which is pushed down by the second projecting shaft 62A of the spool 60 moved by the oil pressure in the first valve chamber 81 upon normal rotation of the drive motor 30, opens the through holes 72D in the second sleeve 72 in a smaller number (two) than the number (three) of through holes 71D opened by the first valve body 73 even when the maximum movement position of the first valve body 73 is set in the position where the stopper 401 is maximally advanced towards the first valve body 73, as shown in FIG. 16. In other words, respective lengths of the contact portion 401A of the stopper 401 and the second projecting shaft 62A of the spool 60 are set such that when the drive motor 30 rotates normally, the second valve body 74 opens the through holes 72D in the second sleeve 72 in a smaller number than the number of through holes 71D opened by the first valve body 73.

In a case where the drive motor 30 rotates in reverse such that the first valve body 73 is pushed down by the spool 60, similar operation control to that of the second embodiment, described above, is performed.

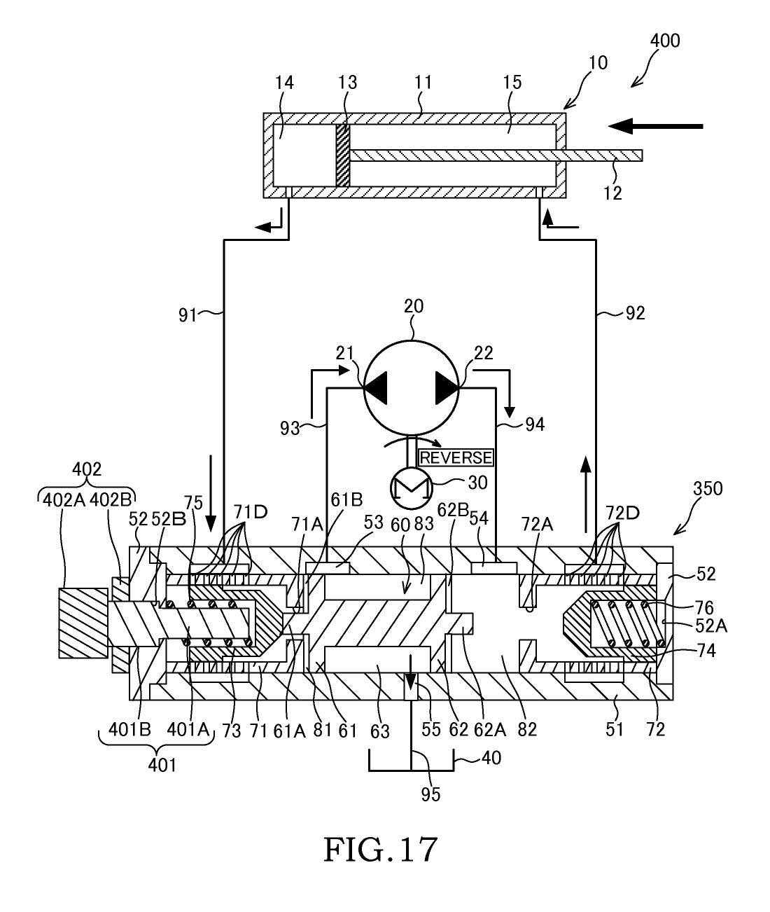

More specifically, as shown in FIG. 17, in a case where the first valve body 73 is pushed down by the spool 60, the first valve body 73 does not contact the contact portion 401A of the stopper 401 even when the stopper 401 is in the maximally advanced position relative to the first valve body 73. In this case, the position of the first valve body 73 is set by the first projecting shaft 61A of the spool 60, which contacts the first sleeve 71.

Hence, when the drive motor 30 rotates in reverse such that the first valve body 73 is pushed down by the spool 60, the stopper 401 and the adjusting mechanism 402 are not affected by the operation control of the cylinder control device 400, and similar operation control to that of the second embodiment, described above, is performed. In other words, the respective lengths of the contact portion 401A of the stopper 401 and the first projecting shaft 61A of the spool 60 are set such that when the drive motor 30 rotates in reverse, the spool 60 contacts the first sleeve 71 before the first valve body 73 contacts the contact portion 401A of the stopper 401.

In the cylinder control device 400, therefore, the maximum movement position (the second position) of the first valve body 73 can be adjusted by restricting sliding of the first valve body 73 in the compression direction of the first spring 75, and in so doing, the expansion speed of the piston rod 12 can be adjusted.

In this embodiment, the stopper 401 and the adjusting mechanism 402 are provided on the first sleeve 71 side so that the expansion speed of the piston rod 12 can be adjusted. Instead, the stopper 401 and the adjusting mechanism 402 may be provided on the second sleeve 72 side so that a contraction speed of the piston rod 12 can be adjusted. Further, the stopper 401 and the adjusting mechanism 402 may be provided on both the first sleeve 71 side and the second sleeve 72 side so that both the expansion speed and the contraction speed can be adjusted.

Furthermore, in this embodiment, the cylinder control device 400 includes the through holes 71D, 72D as the supply/discharge ports that connect the first and second valve chambers 81, 82 to the first and second cylinder passages 91, 92. Instead, similarly to the third embodiment, the cylinder control device 400 is provided with slits as the supply/discharge ports that connect the first and second valve chambers 81, 82 to the first and second cylinder passages 91, 92. Alternatively, the cylinder control device 400 is provided with both slits and through holes as the supply/discharge ports. In other words, the supply/discharge ports that connect the first and second valve chambers 81, 82 to the first and second cylinder passages 91, 92 according to this embodiment may be configured as desired as long as the resistance applied to the working oil passing through the supply/discharge ports can be varied in multiple stages in accordance with the sliding positions of the valve bodies.

Further, the stopper 401 and the adjusting mechanism 402 are not limited to the configurations described above, and may be configured as desired as long as they are capable of restricting sliding (the maximum movement positions) of the first and second valve bodies 73, 74 by contacting the first and second valve bodies 73, 74.

For example, in this embodiment, the stopper 401 is moved by manually rotating the operating portion 402A, which is constituted by a knob, but instead, the screw portion 401B may be omitted from the stopper and the adjusting mechanism 402 may include a solenoid so that the stopper is moved by the solenoid.

According to the fourth embodiment, described above, following effects are obtained in addition to similar effects to those of the second embodiment.

The cylinder control device 400 includes the stopper 401 that restricts sliding of the first valve body 73 in the compression direction of the first spring 75, and the adjusting mechanism 402 that is capable of adjusting the position of the stopper 401. Therefore, the maximum movement position (the second position) of the first valve body 73 can be adjusted, whereby the resistance applied to the working oil supplied to the first cylinder chamber 14 can be adjusted. As a result, the expansion speed of the piston rod 12 can be adjusted.

Embodiments of this invention were described above, but the above embodiments are merely examples of applications of this invention, and the technical scope of this invention is not limited to the specific constitutions of the above embodiments.

The cylinder control devices according to the respective embodiments described above use working oil as a working fluid, but may use an incompressible fluid such as water or an aqueous solution instead of working oil.

Further, the supply/discharge ports that connect the first and second valve chambers 81, 82 to the first and second cylinder passages 91, 92 are constituted by the connecting passages 71B, 72B and the throttle passages 71C, 72C in the first embodiment, the pluralities of through holes 71D, 72D in the second embodiment, and the slits 71E, 72E in the third embodiment. This invention is not limited to these embodiments, however, and instead, for example, the second embodiment and the third embodiment may be combined so as to include a through holes and slits as the supply/discharge ports that connect the first and second valve chambers 81, 82 to the first and second cylinder passages 91, 92. Further, the shapes are not limited to those described in the above embodiments, and instead, for example, the through holes 71D, 72D may be formed such that the diameter thereof decreases gradually toward the communicating ports 71A, 72A while the slits 71E, 72E may be formed such that the width thereof decreases gradually toward the communicating ports.

This application claims priority based on Japanese Patent Application No. 2012-243282 filed with the Japan Patent Office on Nov. 5, 2012, the entire contents of which are incorporated into this specification.

1. A cylinder control device comprising:
a cylinder driven by a fluid pressure of a working fluid in each of two cylinder chambers;
a pump having two ports, the pump being configured to discharge the working fluid selectively from any of the two ports; and
a control valve configured to control a flow of the working fluid, the working fluid flowing between the cylinder and the pump,
wherein the control valve comprises:
a main body portion;
a spool slidably provided in the main body portion;
sleeves provided in the main body portion so as to be respectively opposed to end portions of the spool, valve chambers being respectively defined between the sleeves and the end portions of the spool, the valve chambers being respectively connected to the ports, the sleeves having communicating ports respectively communicating with the valve chambers and supply/discharge ports respectively communicating with the cylinder chambers;
valve bodies respectively provided in the sleeves slidably, each of the valve bodies being configured to control a communication state between the communicating port and the supply/discharge port in accordance with a sliding position thereof; and
biasing members configured to respectively bias the valve bodies in a direction for closing the corresponding communicating port,
wherein, when the pump does not discharge the working fluid, the two valve bodies respectively close the communicating ports in response to biasing forces of the biasing members so that communication between the valve chambers and the cylinder chambers is respectively blocked, and
wherein, when the pump discharges the working fluid into one of the valve chambers from one of the ports,
one of the valve bodies is moved against the biasing force of the corresponding biasing member by means of the fluid pressure in the one valve chamber so as to allow the working fluid to flow from the one valve chamber toward one of the cylinder chambers through one of the supply/discharge ports, and
the other valve body is pushed by the spool and is moved against the biasing force of the corresponding biasing member so that a larger resistance than a resistance applied to the working fluid passing through the one supply/discharge port is applied to the working fluid passing through the other supply/discharge port to allow the working fluid to flow from the other cylinder chamber toward the other valve chamber through the other supply/discharge port, the spool being moved by the fluid pressure in the one valve chamber.

2. The cylinder control device according to claim 1, wherein the supply/discharge port comprises:
a communicating passage communicating with the cylinder chamber; and
a throttle passage communicating with the cylinder chamber, the throttle passage having a smaller flow passage area than that of the communicating passage,
wherein, when the pump discharges the working fluid into the one valve chamber from the one port,
the one valve body is moved against the biasing force of the corresponding biasing member by means of the fluid pressure in the one valve chamber so as to allow the working fluid to flow from the one valve chamber toward the one cylinder chamber through one of the communicating passages and the corresponding throttle passage, and
the other valve body is pushed by the spool and is moved against the biasing force of the corresponding biasing member so that communication between the other communicating port and the other communicating passage is blocked but the other communicating port is communicates with the other throttle passage to allow the working fluid to flow from the other cylinder chamber toward the other valve chamber through the other throttle passage, the spool being moved by the fluid pressure in the one valve chamber.

3. The cylinder control device according to claim 1, wherein the supply/discharge port comprises a plurality of through holes formed so as to be arranged in a sliding direction of the valve body, and
wherein, when the pump discharges the working fluid into the one valve chamber from the one port,
the one valve body is moved against the biasing force of the corresponding biasing member by means of the fluid pressure in the one valve chamber so as to allow the working fluid to flow from the one valve chamber toward the one cylinder chamber through the through holes of the one supply/discharge port, and
the other valve body is pushed by the spool and is moved against the biasing force of the corresponding biasing member so that the through holes of the other supply/discharge port are opened with a smaller number than that of the through holes of
the one supply/discharge port opened by the one valve body to allow the working fluid to flow from the other cylinder chamber toward the other valve chamber through the through holes of the other supply/discharge port, the spool being moved by the fluid pressure in the one valve chamber.

4. The cylinder control device according to claim 1, wherein the supply/discharge port is formed in the sleeve as a slit extending in a sliding direction of the valve body, and
wherein, when the pump discharges the working fluid into the one valve chamber from the one port,
the one valve body is moved against the biasing force of the corresponding biasing member by means of the fluid pressure in the one valve chamber so as to allow the working fluid to flow from the one valve chamber toward the one cylinder chamber through one of the slits,
the other valve body is pushed by the spool and is moved against the biasing force of the corresponding biasing member so that the other slit is opened by a smaller opening area than that of the one slit opened by the one valve body to allow the working
fluid to flow from the other cylinder chamber toward the other valve chamber through the other slit, the spool being moved by the fluid pressure in the one valve chamber.

5. The cylinder control device according to claim 2, wherein the spool comprises a projecting shaft, the projecting shaft projecting outwardly from each of two end portions thereof, the projecting shaft pushing and moving the valve body when the spool moves,
wherein the communicating port is formed in a spool side end surface of the sleeve so that the projecting shaft can be inserted therein, the communicating port being configured to be opened and closed by a tip end portion of the valve body,
wherein the throttle passage and the communicating passage are formed in a side wall of the sleeve, the communicating passage being provided in a position apart from the spool side end surface of the sleeve compared with the throttle passage, the communicating passage being configured to be opened and closed by a sliding wall of the valve body,
wherein, when the valve body is pushed and moved by the projecting shaft, the valve body is pushed down to a first position, the communicating passage being closed at the first position so that the communicating port communicates with only the throttle passage, and
wherein, when the valve body is moved by the fluid pressure in the valve chamber, the valve body is pushed down to a second position, the second position being a position on an outer side of the first position, the communicating port communicating with both the throttle passage and the communicating passage at the first position.

6. The cylinder control device according to claim 3, wherein the spool comprises a projecting shaft, the projecting shaft projecting outwardly from each of two end portions thereof, the projecting shaft pushing and moving the valve body when the spool moves,
wherein the communicating port is formed in a spool side end surface of the sleeve so that the projecting shaft can be inserted therein, the communicating port being configured to be opened and closed by a tip end portion of the valve body,
wherein the through holes are formed in a side wall of the corresponding sleeve, the through holes being configured such that as the valve body approaches the spool side end surface of the sleeve, a part of the through holes is closed by a sliding wall of the valve body to reduce the number of through holes opened to the valve chamber ,
wherein, when the valve body is pushed and moved by the projecting shaft, the valve body is pushed down to a first position, the communicating port communicates communicating with the through holes at the first position in a state where the number of opened through holes is smaller than a maximum number, and
wherein, when the valve body is moved by the fluid pressure in the valve chamber, the valve body is pushed down to a second position, the second position being a position on an outer side of the first position, the communicating port communicating with the through holes at the second position in a state where the number of opened through holes reaches the maximum number.

7. The cylinder control device according to claim 4, wherein the spool comprises a projecting shaft, the projecting shaft projecting outwardly from each of two end portions thereof, the projecting shaft pushing and moving the valve body when the spool moves,
wherein the communicating port is formed in a spool side end surface of the sleeve so that the projecting shaft can be inserted therein, the communicating port being configured to be opened and closed by a tip end portion of the valve body,
wherein the slit is formed in a side wall of the sleeve, the slit being configured such that as the valve body approaches the spool side end surface of the sleeve, an opening portion of the slit is closed by the sliding wall of the valve body to reduce the opening area of the slit opened to the valve chamber,
wherein, when the valve body is pushed and moved by the projecting shaft, the valve body is pushed down to a first position, the communicating port communicating with the slit at the first position in a state where the opening area of the slit is smaller than a maximum opening area, and
wherein, when the valve body is moved by the fluid pressure in the valve chamber, the valve body is pushed down to a second position, the second position being a position on an outer side of the first position, the communicating port communicating with the slit at the second position in a state where the opening area of the slit becomes the maximum opening area.

8. The cylinder control device according to claim 5, wherein a length of the projecting shaft is set to a length by which the valve body is pushed down to the first position in a state where the end portion of the spool contacts the spool side end surface of the sleeve.

9. The cylinder control device according to claim 5, wherein, when the valve body is moved by the fluid pressure in the valve chamber, the valve body is pushed down to the second position to cause the biasing member to maximally compress.

10. The cylinder control device according to claim 1, further comprising:
a stopper configured to restrict sliding of the valve body in a compression direction of the biasing member; and
an adjusting mechanism configured to be capable of adjusting a position of the stopper.

11. The cylinder control device according to claim 10, wherein, when the pump discharges the working fluid into the one valve chamber from the one port,
the one valve body is moved against the biasing force of the corresponding biasing member by means of the fluid pressure in the one valve chamber until the one valve body contacts the stopper, the one supply/discharge port being opened by the movement of the one valve body, and
the other valve body is pushed by the spool and is moved against the biasing force of the corresponding biasing member so that the other supply/discharge port is opened by a smaller opening area than that of the one supply/discharge port opened by the one valve body, the spool being moved by the fluid pressure in the one valve chamber.

12. The cylinder control device according to claim 11, wherein the adjusting mechanism comprises:
an operating portion configured to move the stopper in the sliding direction of the valve body; and
a fixing portion configured to fix the position of the stopper.

13. The cylinder control device according to claim 6, wherein a length of the projecting shaft is set to a length by which the valve body is pushed down to the first position in a state where the end portion of the spool contacts the spool side end surface of the sleeve.

14. The cylinder control device according to claim 7, wherein a length of the projecting shaft is set to a length by which the valve body is pushed down to the first position in a state where the end portion of the spool contacts the spool side end surface of the sleeve.

15. The cylinder control device according to claim 6, wherein, when the valve body is moved by the fluid pressure in the valve chamber, the valve body is pushed down to the second position to cause the biasing member to maximally compress.

16. The cylinder control device according to claim 7, wherein, when the valve body is moved by the fluid pressure in the valve chamber, the valve body is pushed down to the second position to cause the biasing member to maximally compress.

17. The cylinder control device according to claim 8, wherein, when the valve body is moved by the fluid pressure in the valve chamber, the valve body is pushed down to the second position to cause the biasing member to maximally compress.

18. The cylinder control device according to claim 3, further comprising:
a stopper configured to restrict sliding of the valve body in a compression direction of the biasing member; and
an adjusting mechanism configured to be capable of adjusting a position of the stopper.

19. The cylinder control device according to claim 4, further comprising:
a stopper configured to restrict sliding of the valve body in a compression direction of the biasing member; and
an adjusting mechanism configured to be capable of adjusting a position of the stopper.
